(19) United States
(12) Patent Application Publication
(10) Pub. No.: US 2024/0330184 A1
(43) Pub. Date: Oct. 3, 2024

(54) Write-Back Caching with Asynchronous Write-Back Capabilities

(71) Applicant: NetApp, Inc., San Jose, CA (US)

(72) Inventor: Dipankar Roy, San Jose, CA (US)

(21) Appl. No.: 18/542,273

(22) Filed: Dec. 15, 2023

Related U.S. Application Data
(63) Continuation-in-part of application No. 18/194,332, filed on Mar. 31, 2023.

(51) Int. Cl. G06F 12/0813

(52) U.S. Cl. CPC G06F 12/0813

(57) ABSTRACT

A method, computing device, and non-transitory machine-readable medium for performing asynchronous write-backs. Data is written to a cache file in a cache. The cache corresponds to a volume. A tracking metafile is updated based on the data written to the cache file. A record in the tracking metafile is determined to be full. The record corresponds to a group of blocks in the cache file. A write-back of data stored in the group of blocks in the cache file that corresponds to the record to the volume is initiated. The write-back is determined to have been completed. The tracking metafile us updated to indicate that the write-back has been completed.

### CROSS-REFERENCE TO RELATED APPLICATIONS

This application is a continuation-in-part of U.S. Patent Application No. 18,194,332, entitled, “Write-Back Caching Across Clusters,” filed Mar. 31, 2023, which is related to U.S. patent application Ser. No. 18/194,399, Attorney Docket No. 47415.744US01 (P-012613-US2), entitled “Write-Back Caching Across Clusters,” filed Mar. 31, 2023, each of which is incorporated herein by reference in its entirety.

### TECHNICAL FIELD

The present description relates to caching, and more specifically, to methods and systems for write-back caching across clusters.

### BACKGROUND

A cache is a component formed by hardware, software, or both that stores data to enable future requests for data to be served faster. The cache allows for faster retrieval of the data than an underlying data store (e.g., disk). When handling write requests, caching typically occurs based on three different cache writing policies: write-through, write-around, and write-back. With write-through, data is written to the cache and the underlying data store at the same time. Completion of the write request is confirmed once the data has been written to both the cache and the underlying data store. This type of policy ensures fast retrieval but adds to write latency. With write-around, data is written only to the underlying data store without writing to the cache so that completion of the write request is confirmed as soon as the data is written to the underlying data store. This type of policy prevents the cache from being flooded with data that may not be reread but can add to read latency. With write-back, data is written to the cache and completion of the write request confirmed. The data is then also written to the underlying data store with the completion notification not being dependent on this writing. This type of policy provides low latency and high throughput and is therefore preferred in certain situations. However, at least some currently available systems and methods are unable to provide write-back caching within and/or between clusters with the desired level of performance.

### BRIEF DESCRIPTION OF THE DRAWINGS

The present disclosure is best understood from the following detailed description when read with the accompanying figures.

FIG. 1 is a schematic diagram illustrating a computing environment in accordance with one or more example embodiments.

FIG. 2 is a schematic diagram illustrating a network environment in accordance with one or more example embodiments.

FIG. 3 is a schematic block diagram illustrating a cluster environment in accordance with one or more example embodiments.

FIG. 4 is another schematic block diagram for a cluster environment in which the client write request is received by a different node in accordance with one or more example embodiments.

FIG. 5 is a schematic block diagram of the disk module of a node described in greater detail in accordance with one or more example embodiments.

FIG. 6 is an illustration of one example of a configuration for the tracking metafile and asynchronous write-back tracker from FIGS. 3-4 in accordance with one or more example embodiments.

FIG. 7 is a flow diagram of a process for write-back caching in accordance with one or more example embodiments.

FIG. 8 is a flow diagram of a process for write-back caching in accordance with one or more example embodiments.

FIG. 9 is a flow diagram of a process for write-back caching in accordance with one or more example embodiments.

FIG. 10 is a flow diagram of a process for clearing at least a portion of a cache in accordance with one or more example embodiments.

FIG. 11 is a flow diagram of a process for generating a write request in accordance with one or more example embodiments.

FIG. 12 is a flow diagram of a process for managing access to a selected file on a volume in accordance with one or more example embodiments.

FIG. 13 is a flow diagram of a process for performing asynchronous write-back in accordance with one or more example embodiments.

FIG. 14 is a flow diagram of a process for tracking asynchronous write-back operations in accordance with one or more example embodiments.

FIG. 15 is a flow diagram of a process for managing a tracking metafile in accordance with one or more example embodiments.

FIG. 16 is a flow diagram of a process for managing write operations in accordance with one or more example embodiments.

### DETAILED DESCRIPTION

### 1. Overview

The embodiments described herein recognize that write-back caching can provide reduced write latency and high throughput. However, the nature of clustered networks can make write-back caching challenging. In particular, write-back caching in clustered networks using currently available methods may be faced with performance limitations that make using such write-back caching difficult for large datasets.

For example, in certain architectures, write-back caching within a same cluster (e.g., both the cache and its corresponding volume are hosted by nodes within the same cluster) may be faced with limits regarding the maximum amount of data that can be written to a file in a cache in a single write operation and the maximum amount of data that can be written back to the corresponding volume in a single write-back message. When the maximum amount of data that can be written to a file in the cache is small (e.g., 64 kilobytes), write-back operations to write-back the data from the cache to the corresponding volume are triggered more frequently. The data is written back to the volume prior to the cache being able to accept another write operation to write data to the same file in the cache. When the maximum amount of data that can be written back to the corresponding volume in a single write-back message is small (e.g., 64 kilobytes), multiple write-back messages are needed to fully write-back the data that has accumulated in the cache to the corresponding volume.

These types of limitations may result in decreased write-back performance for large datasets as compared to other types of caching policies (e.g., write-around caching). Such performance may be tolerable or otherwise acceptable for writes involving small amounts of data within the same cluster but unacceptable for large datasets where performance issues can be costly. Further, such limitations as those described above may increase write latency and decrease throughput in cross-cluster (or intercluster) communications in a manner that is unacceptable.

Additionally, some currently available methods for write-back caching may face challenges in keeping data consistent at the volume underlying the cache with data and records resilient enough to be maintained between the cache and underlying volume across various scenarios where cross-cluster communications are occurring. Such scenarios include, for example, but are not limited to, shutdowns, reboots, etc.

Thus, the embodiments described herein provide methods, systems, and machine-readable media for enabling write-back caching across clusters without sacrificing write performance. Write-back caching across clusters may include write-back caching within a same cluster of nodes, between two or more clusters of nodes, or both. The embodiments described herein provide techniques that enable write-back caching across clusters with reduced write latency and increased throughput. In this manner, the embodiments described herein improve the functioning of the computing devices on which these techniques are implemented.

In one or more embodiments, a write request is received at the disk module (or data module) of a first node in a cluster network that includes one or more clusters of nodes. The write request, which may have originated from a client, is to write data to a selected file on a volume that is managed (or owned, hosted, etc.) by a second node. In some cases, the second node is within a same cluster as the first node. In other cases, the two nodes belong to two different clusters but are capable of communicating with each other over a cluster interface. In one or more embodiments, the write request received at the disk module may be a modified version of the client's original write request (or client write request) that is received. For example, the client write request may be received at the network module of the first node, processed (e.g., modified or otherwise transformed to form the write request), and then passed as the write request to the disk module of the first node for processing. In another example, the client write request may be received at the network module of a different node. This other node may process the client write request to generate the write request that is then forwarded on to the disk module of the first node via the cluster interface.

The disk module, if it does not already have authorization to write to the volume, obtains this authorization. This authorization may be referred to as, for example, a write delegation. In one or more embodiments, the disk module determines whether writing the data in the write request to the cache in a cache file that corresponds to the selected file identified by the client write request will cause a cache file threshold to be met. If performing the write will not cause the cache file threshold to be met, the write occurs.

If, however, performing the write will cause the cache file threshold to be met, the cache file is flushed or cleared. In other words, the disk module initiates a write-back that results in one or more write-back messages being sent to write the data that has accumulated in the cache file to the selected file in the corresponding volume. Once these write-back messages have been sent and the data written back to the corresponding volume, the cache file is flushed. Although these write-back messages are sent and processed one at a time, the payload size of these write-back messages may be tunable to improve write latency and throughput. Once the cache file has been flushed, the data is written to the cache file and the disk module generates and sends a response that the write has been completed. In one or more embodiments, the response is sent from the disk module to the client via the network module in communication with the client. The terms “flushed” and “cleared,” or derivatives thereof, with respect to the cache file or cache may be used interchangeably herein.

In some embodiments, the disk module also determines whether writing the data to the cache file in the cache will cause a cache threshold to be met. The cache threshold is a threshold for the entire cache so that the cache does not ever hold an overly large amount of data that has yet to be written back to the corresponding volume. The cache threshold helps ensure data consistency and resiliency in the face of certain scenarios (e.g., shutdowns, reboots, hardware/software failure, etc.).

If performing the write will not cause the cache threshold to be met, the write occurs. If, however, performing the write will cause the cache threshold to be met, at least a portion of the accumulated data in the cache is flushed. In some cases, the entire cache is flushed. Once the cache has been flushed, the data is written to the cache file corresponding to the selected file and the disk module generates and sends a response that the write has been completed.

In one or more embodiments, the disk module runs an idle scrubber that runs in response to the occurrence of a trigger event to determine whether an idle threshold has been met for any cache files in the cache. The idle threshold may be the amount of time that a cache file has remained unmodified (or unwritten to). If the idle threshold is met for any cache files, those cache files are flushed. The trigger event for running the idle scrubber may be, for example, the lapse of a timer such that the idle scrubber is run at a predetermined interval (e.g., every 30 seconds, 1 minutes, 2 minutes, 3 minutes, 5 minutes, etc.). The cache threshold helps ensure data consistency and resiliency in the face of certain scenarios (e.g., shutdowns, reboots, hardware/software failure, etc.).

Each of the cache file threshold, the cache threshold, the idle threshold, and the payload size of the write-back messages is a tunable parameter that can be selected to ensure the desired level of write performance. For example, these parameters can be set to reduce write latency, increase throughput, or both. These parameters may also be tuned based on performance requirements, expected workloads, observed workloads, or a combination thereof. Tuning of a parameter may be performed by a network administrator or may be performed automatically based on observations, (e.g., observed workloads), measurements, performance requirements, one or more predefined rules, one or more criteria being met, or a combination thereof.

Further, these parameters may help maintain data consistency and resiliency. For example, the cache file threshold, the cache threshold, and the idle threshold may be set to help prevent data buildup at the cache, which may help avoid a rush to get the data written to the corresponding volume at the time of, for example, a snapshot.

Additionally, the embodiments described herein provide methods, systems, and machine-readable media for enabling asynchronous write-backs. Specifically, the methods, systems, and machine-readable media described herein enable writing data from the cache to the volume without interfering with or interrupting writes to the cache. The embodiments described herein also enable multiple write-back operations to be performed concurrently to enable quick and efficient transfer (e.g., flushing) of data from the cache to the volume.

In one or more embodiments, a tracking metafile and asynchronous write-back tracker are used to allow performance of asynchronous write-back operations. The tracking metafile is implemented as a hierarchical structure (e.g., tree structure) that allows each cache file in the cache to be associated with one or more records in the tracking metafile. Each record in the tracking metafile corresponds to a specific group of blocks, also called data blocks, in a corresponding cache file. The group of blocks are indexed by corresponding file block numbers. The specific group of data blocks may be, for example, without limitation, a sequence of data blocks. Accordingly, the group of blocks may have a corresponding sequence of file block numbers. When one or more blocks in a specific sequence of blocks is modified (e.g., by being newly written to, by having existing data modified, or being otherwise “dirtied”), the tracking metafile is updated. This updating may include, for example, updating an existing record to the tracking metafile or adding a new record to the tracking metafile. The record that is either updated or added includes a bitmap that represents the corresponding sequence of blocks (or data blocks). The bitmap is an array of bits, each bit representing at least one different block (e.g., in sequential order based on file block number) of the group of blocks. Thus, a bit may represent a set of (i.e., one or more) blocks within the group of blocks. Each bit is assigned a value that indicates whether the corresponding data block has been modified.

A record is considered “full” when the bitmap indicates that all blocks in the sequence of blocks has been modified. For example, a bit may have a value of “0” to indicate that a data block represented by that bit is unmodified and a value of “1” to indicate that the data block has been modified. In this example, a record may be “full” when all bits in the bitmap have the value of “1.” In other embodiments, a bit may have a value of “1” to indicate that a data block represented by that bit is unmodified and a value of “0” to indicate that the data block has been modified. In these other embodiments, a record may be “full” when all bits in the bitmap have the value of “0.”

Whenever a record is determined to be full, a write-back operation is initiated to write-back data stored in the sequence of blocks to the volume. Before, concurrently with, after, or as part of initiation of the write-back, a data structure used for asynchronous write-back tracking is updated to indicate that the data associated with the record (e.g., the data stored in the sequence of blocks represented by the record) is undergoing a write-back operation. For example, the data structure may be a hash data structure. Updating the hash data structure may include adding an entry for the record. This data structure may be consulted whenever a new write request to write data to the cache is received. For example, a write to a block(s) in the sequence of blocks represented by the record may need to be retried if that sequence of blocks is undergoing a write-back operation. In this manner, data loss that might otherwise occur due to concurrent writes and write-backs may be prevented.

Once the write-back is completed, the tracking metafile is updated to indicate that the write-back has been completed for the group of blocks represented by the record. Updating the tracking metafile may include, for example, deleting the record from the tracking metafile to indicate that the corresponding group of blocks is available for modification (e.g., written to or over). In other examples, updating the tracking metafile may include changing the value of the bits in the bitmap of the record to indicate that the corresponding group of blocks is available for future writes. In other words, data may be written to the group of blocks since the previous data stored in the group of blocks has been written to the volume.

Further, the hash data structure is updated to indicate that the write-back has been completed. Updating the hash data structure may include, for example, deleting the corresponding entry that was added to the hash data structure. Deleting the entry indicates that writes may now be permitted for that group of blocks in the cache.

In this manner, multiple write-backs from cache to volume can be performed in parallel (concurrently) without interfering with each other or with ongoing and/or new writes to the cache. Thus, the embodiments described herein improve the functioning of a computing platform by providing a simple, quick, and efficient way of performing write-back operations that include asynchronous write-back operations.

### II. Exemplary Architectures for Computing/Networking Environments

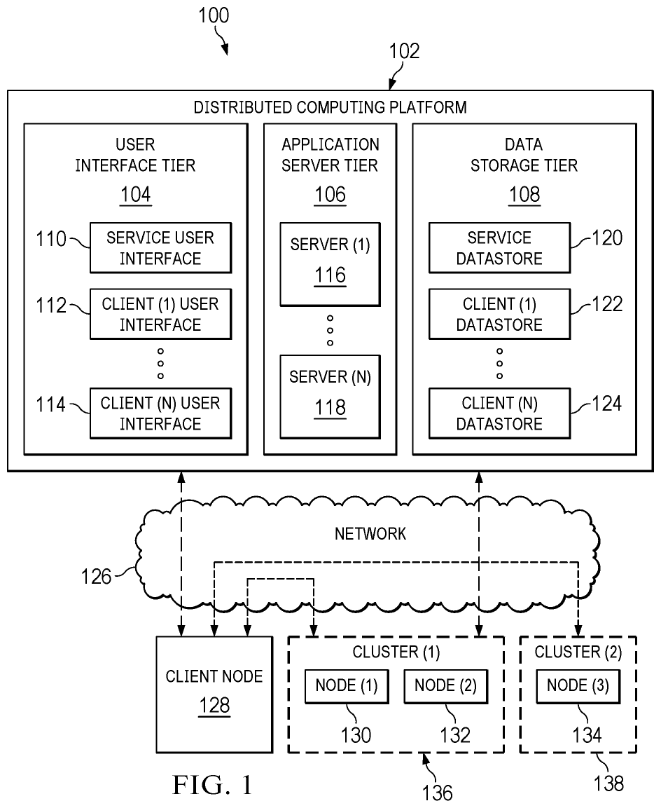

Referring now to the figures, FIG. 1 is a schematic diagram illustrating a computing environment 100 in accordance with one or more example embodiments. The computing environment 100 may be one example of an implementation for an environment in which write-back caching across clusters is performed. The computing environment 100 includes a distributed computing platform 102 that can be used to manage the storage of and access to data on behalf of client devices and/or storage resources. The distributed computing environment 100 may be implemented using a cloud storage environment, a multi-tenant platform, a hyperscale infrastructure comprising scalable server architectures, virtual networking, or a combination thereof.

The distributed computing platform 102 may include, for example, a user interface tier 104, an application server tier 106, and a data storage tier 108. The user interface tier 104 may include a service user interface 110 and one or more client user interfaces for one or more respective client nodes. For example, the one or more client user interfaces may include client (1) user interface 112 and, in some cases, one or more other client user interfaces up to client (N) user interface 114. The application server tier 106 may include one or more servers including, for example, server (1) 116 up to server (N) 118. The number of servers in application server tier 106 may be the same as or different from the number of client user interfaces in user interface tier 104. The data storage tier 108 includes service datastore 120 and one or more client datastores for one or more respective client nodes. For example, the one or more client datastores may include client (1) datastore 122 and, in some cases, one or more other client datastores up to client (N) datastore 124.

The distributed computing platform 102 is in communication via network 126 with one or more client nodes (e.g., client node 128), one or more nodes (e.g., a first node 130, a second node 132, a third node 134, etc.), or both, where the various nodes may form one or more clusters (e.g., a first cluster 136, a second cluster 138, etc.). The embodiments described herein may include actions that can be implemented within a client node (e.g., the client node 128), one or more nodes (e.g., the first node 130, the second node 132, the third node 134), or both. A node may include a storage controller, a server, an on-premise device, a virtual machine such as a storage virtual machine, hardware, software, or a combination thereof. The one or more nodes may be configured to manage the storage and access to data on behalf of the client node 128 and/or other client devices.

One or more of the embodiments described herein include operations implemented across the distributed computing platform 102, client node 128, one or more of first node 130, second node 132, and/or third node 134, or a combination thereof. For example, the client node 128 may transmit operations, such as data operations to read data and write data, and metadata operations (e.g., a create file operation, a rename directory operation, a resize operation, a set attribute operation, etc.), over the network 126 to the first node 130 for implementation by the first node 130 upon storage. The first node 130 may store data associated with the operations within volumes or other data objects/structures hosted within locally attached storage, remote storage hosted by other computing devices accessible over the network 126, storage provided by the distributed computing platform 102, etc. The first node 130 may replicate the data and/or the operations to other computing devices, such as to the second node 132, the third node 134, a storage virtual machine executing within the distributed computing platform 102, etc., so that one or more replicas of the data are maintained. For example, the third node 134 may host a destination storage volume that is maintained as a replica of a source storage volume of the first node 130. Such replicas can be used for disaster recovery and failover.

In one or more embodiments, the techniques described herein include actions implemented by a storage operating system or are implemented by a separate module that interacts with the storage operating system. The storage operating system may be hosted by the client node 128, the distributed computing platform 102, or across a combination thereof. In an example, the storage operating system may execute within a storage virtual machine, a hyperscaler, or some other computing environment. The storage operating system may implement a storage file system to logically organize data within storage devices as one or more storage objects and provide a logical/virtual representation of how the storage objects are organized on the storage devices. A storage object may comprise any logically definable storage element stored by the storage operating system (e.g., a volume stored by the first node 130, a cloud object stored by the distributed computing platform 102, etc.). Each storage object may be associated with a unique identifier that uniquely identifies the storage object. For example, a volume may be associated with a volume identifier uniquely identifying that volume from other volumes. The storage operating system also manages client access to the storage objects.

The storage operating system may implement a file system for logically organizing data. For example, the storage operating system may implement a write-anywhere file layout for a volume where modified data for a file may be written to any available location as opposed to a write-in-place architecture where modified data is written to the original location, thereby overwriting the previous data.

In one or more embodiments, the file system may be implemented through a file system layer that stores data of the storage objects in an on-disk format representation that is block-based (e.g., data may be stored within 4 kilobyte blocks). Pointer elements may be used to identify files and file attributes such as creation time, access permissions, size and block location, other types of attributes, or a combination thereof. Such pointer elements may be referred to as index nodes (inodes). For example, an inode may be a data structure that points to a file system object (e.g., a file, a folder, or a directory) in the file system. The inode may point to blocks that make up a file and may also contain the metadata of the file. In some cases, an inode may itself have a certain capacity and may be able to store a file itself. As one example, the inode may have a 288-byte capacity and may be capable of storing a file that is less than 64 bytes. In one or more embodiments, a given volume may have a finite number of inodes.

In one or more embodiments, deduplication may be implemented by a deduplication module associated with the storage operating system to improve storage efficiency. For example, inline deduplication may ensure blocks are deduplicated before being written to a storage device. Inline deduplication uses a data structure, such as an in-core hash store, which maps fingerprints of data-to-data blocks of the storage device storing the data. Whenever data is to be written to the storage device, a fingerprint of that data is calculated, and the data structure is looked up using the fingerprint to find duplicates (e.g., potentially duplicate data already stored within the storage device). If duplicate data is found, then the duplicate data is loaded from the storage device and a byte-by-byte comparison may be performed to ensure that the duplicate data is an actual duplicate of the data to be written to the storage device. If the data to be written is a duplicate of the loaded duplicate data, then the data to be written to disk is not redundantly stored to the storage device. Instead, a pointer or other reference is stored in the storage device in place of the data to be written to the storage device. The pointer points to the duplicate data already stored in the storage device. A reference count for the data may be incremented to indicate that the pointer now references the data. If at some point the pointer no longer references the data (e.g., the deduplicated data is deleted and thus no longer references the data in the storage device), then the reference count is decremented. In this way, inline deduplication is able to deduplicate data before the data is written to disk. This improves the storage efficiency of the storage device.

In one or more embodiments, compression may be implemented by a compression module associated with the storage operating system. The compression module may utilize various types of compression techniques to replace longer sequences of data (e.g., frequently occurring and/or redundant sequences) with shorter sequences, such as by using Huffman coding, arithmetic coding, compression dictionaries, etc. For example, an uncompressed portion of a file may comprise “ggggnnnnnnqqqqqqqqqq”, which is compressed to become “4g6n10q”. In this way, the size of the file can be reduced to improve storage efficiency. Compression may be implemented for compression groups. A compression group may correspond to a compressed group of blocks. The compression group may be represented by virtual volume block numbers. The compression group may comprise contiguous or non-contiguous blocks.

In one or more embodiments, various types of synchronization may be implemented by a synchronization module associated with the storage operating system. In an example, synchronous replication may be implemented, such as between the first node 130 and the second node 132. It may be appreciated that the synchronization module may implement synchronous replication between any devices within the computing environment 100, such as between the first node 130 of the first cluster 136 and the third node 134 of the second cluster 138 and/or between a node of a cluster and an instance of a node or virtual machine in the distributed computing platform 102.

For example, during synchronous replication, the first node 130 may receive a write operation from the client node 128. The write operation may target a file stored within a volume managed by the first node 130. The first node 130 replicates the write operation to create a replicated write operation. The first node 130 locally implements the write operation upon the file within the volume. The first node 130 also transmits the replicated write operation to a synchronous replication target, such as the second node 132 that maintains a replica volume as a replica of the volume maintained by the first node 130. The second node 132 will execute the replicated write operation upon the replica volume so that file within the volume and the replica volume comprises the same data. After, the second node 132 will transmit a success message to the first node 130. With synchronous replication, the first node 130 does not respond with a success message to the client node 128 for the write operation until the write operation is executed upon the volume and the first node 130 receives the success message that the second node 132 executed the replicated write operation upon the replica volume.

In other embodiments, asynchronous replication may be implemented, such as between the first node 130 and the third node 134. It may be appreciated that the synchronization module may implement asynchronous replication between any devices within the computing environment 100, such as between the first node 130 of the first cluster 136 and the distributed computing platform 102. In an example, the first node 130 may establish an asynchronous replication relationship with the third node 134. The first node 130 may capture a baseline snapshot of a first volume as a point in time representation of the first volume. The first node 130 may utilize the baseline snapshot to perform a baseline transfer of the data within the first volume to the third node 134 in order to create a second volume within the third node 134 comprising data of the first volume as of the point in time at which the baseline snapshot was created.

After the baseline transfer, the first node 130 may subsequently create snapshots of the first volume over time. As part of asynchronous replication, an incremental transfer is performed between the first volume and the second volume. In particular, a snapshot of the first volume is created. The snapshot is compared with a prior snapshot that was previously used to perform the last asynchronous transfer (e.g., the baseline transfer or a prior incremental transfer) of data to identify a difference in data of the first volume between the snapshot and the prior snapshot (e.g., changes to the first volume since the last asynchronous transfer). Accordingly, the difference in data is incrementally transferred from the first volume to the second volume. In this way, the second volume will comprise the same data as the first volume as of the point in time when the snapshot was created for performing the incremental transfer. It may be appreciated that other types of replication may be implemented, such as semi-sync replication.

In one or more embodiments, the first node 130 may store data or a portion thereof within storage hosted by the distributed computing platform 102 by transmitting the data within objects to the distributed computing platform 102. In one example, the first node 130 may locally store frequently accessed data within locally attached storage. Less frequently accessed data may be transmitted to the distributed computing platform 102 for storage within a data storage tier 108. The data storage tier 108 may store data within a service datastore 120. Further, the data storage tier 108 may store client specific data within client data stores assigned to such clients such as a client (1) datastore 122 used to store data of a client (1) and a client (N) datastore 124 used to store data of a client (N). The data stores may be physical storage devices or may be defined as logical storage, such as a virtual volume, logical unit numbers (LUNs), or other logical organizations of data that can be defined across one or more physical storage devices. In another example, the first node 130 transmits and stores all client data to the distributed computing platform 102. In yet another example, the client node 128 transmits and stores the data directly to the distributed computing platform 102 without the use of the first node 130.

The management of storage and access to data can be performed by one or more storage virtual machines (SVMs) or other storage applications that provide software as a service (SaaS) such as storage software services. In one example, an SVM may be hosted within the client node 128, within the first node 130, or within the distributed computing platform 102 such as by the application server tier 106. In another example, one or more SVMs may be hosted across one or more of the client node 128, the first node 130, and the distributed computing platform 102. The one or more SVMs may host instances of the storage operating system.

In one or more embodiments, the storage operating system may be implemented for the distributed computing platform 102. The storage operating system may allow client devices to access data stored within the distributed computing platform 102 using various types of protocols, such as a Network File System (NFS) protocol, a Server Message Block (SMB) protocol and Common Internet File System (CIFS), and Internet Small Computer Systems Interface (ISCSI), and/or other protocols. The storage operating system may provide various storage services, such as disaster recovery (e.g., the ability to non-disruptively transition client devices from accessing a primary node that has failed to a secondary node that is taking over for the failed primary node), backup and archive function, replication such as asynchronous and/or synchronous replication, deduplication, compression, high availability storage, cloning functionality (e.g., the ability to clone a volume, such as a space efficient flex clone), snapshot functionality (e.g., the ability to create snapshots and restore data from snapshots), data tiering (e.g., migrating infrequently accessed data to slower/cheaper storage), encryption, managing storage across various platforms such as between on-premise storage systems and multiple cloud systems, etc.

In one example of the distributed computing platform 102, one or more SVMs may be hosted by the application server tier 106. For example, a server (1) 116 is configured to host SVMs used to execute applications such as storage applications that manage the storage of data of the client (1) within the client (1) datastore 122. Thus, an SVM executing on the server (1) 116 may receive data and/or operations from the client node 128 and/or the first node 130 over the network 126. The SVM executes a storage application and/or an instance of the storage operating system to process the operations and/or store the data within the client (1) datastore 122. The SVM may transmit a response back to the client node 128 and/or the first node 130 over the network 126, such as a success message or an error message. In this way, the application server tier 106 may host SVMs, services, and/or other storage applications using the server (1) 116, the server (N) 118, etc.

A user interface tier 104 of the distributed computing platform 102 may provide the client node 128 and/or the first node 130 with access to user interfaces associated with the storage and access of data and/or other services provided by the distributed computing platform 102. In an example, a service user interface 110 may be accessible from the distributed computing platform 102 for accessing services subscribed to by clients and/or nodes, such as data replication services, application hosting services, data security services, human resource services, warehouse tracking services, accounting services, etc. For example, client user interfaces may be provided to corresponding clients, such as a client (1) user interface 112, a client (N) user interface 114, etc. The client (1) can access various services and resources subscribed to by the client (1) through the client (1) user interface 112, such as access to a web service, a development environment, a human resource application, a warehouse tracking application, and/or other services and resources provided by the application server tier 106, which may use data stored within the data storage tier 108.

The client node 128 and/or the first node 130 may subscribe to certain types and amounts of services and resources provided by the distributed computing platform 102. For example, the client node 128 may establish a subscription to have access to three virtual machines, a certain amount of storage, a certain type/amount of data redundancy, a certain type/amount of data security, certain service level agreements (SLAs) and service level objectives (SLOs), latency guarantees, bandwidth guarantees, access to execute or host certain applications, etc. Similarly, the first node 130 can establish a subscription to have access to certain services and resources of the distributed computing platform 102.

As shown, a variety of clients, such as the client node 128 and the first node 130, incorporating and/or incorporated into a variety of computing devices may communicate with the distributed computing platform 102 through one or more networks, such as the network 126. For example, a client may incorporate and/or be incorporated into a client application (e.g., software) implemented at least in part by one or more of the computing devices.

Examples of computing devices include, but are not limited to, personal computers, server computers, desktop computers, nodes, storage servers, nodes, laptop computers, notebook computers, tablet computers or personal digital assistants (PDAs), smart phones, cell phones, and consumer electronic devices incorporating one or more computing device components, such as one or more electronic processors, microprocessors, central processing units (CPU), or controllers. Examples of networks include, but are not limited to, networks utilizing wired and/or wireless communication technologies and networks operating in accordance with any suitable networking and/or communication protocol (e.g., the Internet). In use cases involving the delivery of customer support services, the computing devices noted represent the endpoint of the customer support delivery process, i.e., the consumer's device.

The distributed computing platform 102, which may be implemented using a multi-tenant business data processing platform or cloud computing environment, may include multiple processing tiers, including the user interface tier 104, the application server tier 106, and a data storage tier 108. The user interface tier 104 may maintain multiple user interfaces, including graphical user interfaces and/or web-based interfaces. The user interfaces may include the service user interface 110 for a service to provide access to applications and data for a client (e.g., a “tenant”) of the service, as well as one or more user interfaces that have been specialized/customized in accordance with user specific requirements (e.g., as discussed above), which may be accessed via one or more APIs.

The service user interface 110 may include components enabling a tenant to administer the tenant's participation in the functions and capabilities provided by the distributed computing platform 102, such as accessing data, causing execution of specific data processing operations, etc. Each processing tier may be implemented with a set of computers, virtualized computing environments such as a storage virtual machine or storage virtual server, and/or computer components including computer servers and processors, and may perform various functions, methods, processes, or operations as determined by the execution of a software application or set of instructions.

The data storage tier 108 may include one or more data stores, which may include the service datastore 120 and one or more client data stores 122-124. Each client data store may contain tenant-specific data that is used as part of providing a range of tenant-specific business and storage services or functions, including but not limited to ERP, CRM, eCommerce, Human Resources management, payroll, storage services, etc. Data stores may be implemented with any suitable data storage technology, including structured query language (SQL) based relational database management systems (RDBMS), file systems hosted by operating systems, object storage, etc.

The distributed computing platform 102 may be a multi-tenant and service platform operated by an entity in order to provide multiple tenants with a set of business related applications, data storage, and functionality. These applications and functionality may include ones that a business uses to manage various aspects of its operations. For example, the applications and functionality may include providing web-based access to business information systems, thereby allowing a user with a browser and an Internet or intranet connection to view, enter, process, or modify certain types of business information or any other type of information.

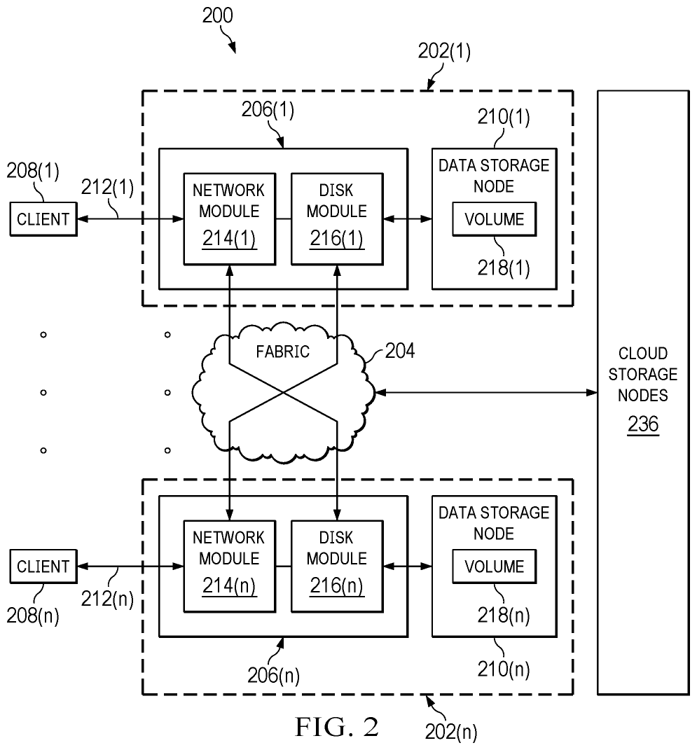

FIG. 2 is a schematic diagram illustrating a network environment 200 in accordance with one or more example embodiments. The network environment 200 illustrates another architecture for the principles described above with respect to FIG. The network environment 200, which may take the form of a clustered network environment, includes data storage apparatuses 202(1)-202(n) that are coupled over a cluster or cluster fabric 204 that includes one or more communication network(s) and facilitates communication between the data storage apparatuses 202(1)-202(n) (and one or more modules, components, etc. therein, such as, node computing devices 206(1)-206(n) (also referred to as node computing devices), for example), although any number of other elements or components can also be included in the network environment 200 in other examples. This technology provides a number of advantages including methods, non-transitory computer-readable media, and computing devices that implement the techniques described herein.

In this example, node computing devices 206(1)-206(n) can be primary or local storage controllers or secondary or remote storage controllers that provide client devices 208(1)-208(n) (also referred to as client nodes) with access to data stored within data storage nodes 210(1)-210(n) (also referred to as data storage devices) and cloud storage node(s) 236 (also referred to as cloud storage device(s)). The node computing devices 206(1)-206(n) may be implemented as hardware, software (e.g., a storage virtual machine), or combination thereof.

The data storage apparatuses 202(1)-202(n) and/or node computing devices 206(1)-206(n) of the examples described and illustrated herein are not limited to any particular geographic areas and can be clustered locally and/or remotely via a cloud network, or not clustered in other examples. Thus, in one example the data storage apparatuses 202(1)-202(n) and/or node computing device 206(1)-206(n) can be distributed over a plurality of storage systems located in a plurality of geographic locations (e.g., located on-premise, located within a cloud computing environment, etc.); while in another example a network can include data storage apparatuses 202(1)-202(n) and/or node computing device 206(1)-206(n) residing in a same geographic location (e.g., in a single on-site rack).

In the illustrated example, one or more of the client devices 208(1)-208(n), which may be, for example, personal computers (PCs), computing devices used for storage (e.g., storage servers), or other computers or peripheral devices, are coupled to the respective data storage apparatuses 202(1)-202(n) by network connections 212(1)-212(n). Network connections 212(1)-212(n) may include a local area network (LAN) or wide area network (WAN) (i.e., a cloud network), for example, that utilize TCP/IP and/or one or more Network Attached Storage (NAS) protocols, such as a Common Internet Filesystem (CIFS) protocol or a Network Filesystem (NFS) protocol to exchange data packets, a Storage Area Network (SAN) protocol, such as Small Computer System Interface (SCSI) or Fiber Channel Protocol (FCP), an object protocol, such as simple storage service (S3), and/or non-volatile memory express (NVMe), for example.

Illustratively, the client devices 208(1)-208(n) may be general-purpose computers running applications and may interact with the data storage apparatuses 202(1)-202(n) using a client/server model for exchange of information. That is, the client devices 208(1)-208(n) may request data from the data storage apparatuses 202(1)-202(n) (e.g., data on one of the data storage nodes 210(1)-210(n) managed by a network storage controller configured to process I/O commands issued by the client devices 208(1)-208(n)), and the data storage apparatuses 202(1)-202(n) may return results of the request to the client devices 208(1)-208(n) via the network connections 212(1)-212(n).

The node computing devices 206(1)-206(n) of the data storage apparatuses 202(1)-202(n) can include network or host nodes that are interconnected as a cluster to provide data storage and management services, such as to an enterprise having remote locations, cloud storage (e.g., a storage endpoint may be stored within cloud storage node(s) 236), etc., for example. Such node computing devices 206(1)-206(n) can be attached to the cluster fabric 204 at a connection point, redistribution point, or communication endpoint, for example. One or more of the node computing devices 206(1)-206(n) may be capable of sending, receiving, and/or forwarding information over a network communications channel, and could comprise any type of device that meets any or all of these criteria.

In an example, the node computing devices 206(1) and 206(n) may be configured according to a disaster recovery configuration whereby a surviving node provides switchover access to the storage nodes 210(1)-210(n) in the event a disaster occurs at a disaster storage site (e.g., the node computing device 206(1) provides client device 208(n) with switchover data access to data storage nodes 210(n) in the event a disaster occurs at the second storage site). In other examples, the node computing device 206(n) can be configured according to an archival configuration and/or the node computing devices 206(1)-206(n) can be configured based on another type of replication arrangement (e.g., to facilitate load sharing). Additionally, while two node computing devices are illustrated in FIG. 2, any number of node computing devices or data storage apparatuses can be included in other examples in other types of configurations or arrangements.

As illustrated in the network environment 200, node computing devices 206(1)-206(n) can include various functional components that coordinate to provide a distributed storage architecture. For example, the node computing devices 206(1)-206(n) can include network modules 214(1)-214(n) and disk modules 216(1)-216(n). Network modules 214(1)-214(n) can be configured to allow the node computing devices 206(1)-206(n) (e.g., network storage controllers) to connect with client devices 208(1)-208(n) over the network connections 212(1)-212(n), for example, allowing the client devices 208(1)-208(n) to access data stored in the network environment 200.

Further, the network modules 214(1)-214(n) can provide connections with one or more other components through the cluster fabric 204. For example, the network module 214(1) of node computing device 206(1) can access the data storage node 210(n) by sending a request via the cluster fabric 204 through the disk module 216(n) of node computing device 206(n) when the node computing device 206(n) is available. Alternatively, when the node computing device 206(n) fails, the network module 214(1) of node computing device 206(1) can access the data storage node 210(n) directly via the cluster fabric 204. The cluster fabric 204 can include one or more local and/or wide area computing networks (i.e., cloud networks) embodied as Infiniband, Fibre Channel (FC), or Ethernet networks, for example, although other types of networks supporting other protocols can also be used.

Disk modules 216(1)-216(n) can be configured to connect data storage nodes 210(1)-210(n), such as disks or arrays of disks, SSDs, flash memory, or some other form of data storage, to the node computing devices 206(1)-206(n). Often, disk modules 216(1)-216(n) communicate with the data storage nodes 210(1)-210(n) according to the SAN protocol, such as SCSI or FCP, for example, although other protocols can also be used. Thus, as seen from an operating system on node computing devices 206(1)-206(n), the data storage nodes 210(1)-210(n) can appear as locally attached. In this manner, different node computing devices 206(1)-206(n), etc. may access data blocks, files, or objects through the operating system, rather than expressly requesting abstract files.

While the network environment 200 illustrates an equal number of network modules 214(1)-214(n) and disk modules 216(1)-216(n), other examples may include a differing number of these modules. For example, there may be a plurality of network and disk modules interconnected in a cluster that do not have a one-to-one correspondence between the network and disk modules. That is, different node computing devices can have a different number of network and disk modules, and the same node computing device can have a different number of network modules than disk modules.

Further, one or more of the client devices 208(1)-208(n) can be networked with the node computing devices 206(1)-206(n) in the cluster, over the network connections 212(1)-212(n). As an example, respective client devices 208(1)-208(n) that are networked to a cluster may request services (e.g., exchanging of information in the form of data packets) of node computing devices 206(1)-206(n) in the cluster, and the node computing devices 206(1)-206(n) can return results of the requested services to the client devices 208(1)-208(n). In one example, the client devices 208(1)-208(n) can exchange information with the network modules 214(1)-214(n) residing in the node computing devices 206(1)-206(n) (e.g., network hosts) in the data storage apparatuses 202(1)-202(n).

In one example, the data storage apparatuses 202(1)-202(n) host aggregates corresponding to physical local and remote data storage devices, such as local flash or disk storage in the data storage nodes 210(1)-210(n), for example. One or more of the data storage nodes 210(1)-210(n) can include mass storage devices, such as disks of a disk array. The disks may comprise any type of mass storage devices, including but not limited to magnetic disk drives, flash memory, and any other similar media adapted to store information, including, for example, data and/or parity information.

The aggregates include volumes 218(1)-218(n) in this example, although any number of volumes can be included in the aggregates. The volumes 218(1)-218(n) are virtual data stores or storage objects that define an arrangement of storage and one or more filesystems within the network environment 200. Volumes 218(1)-218(n) can span a portion of a disk or other storage device, a collection of disks, or portions of disks, for example, and typically define an overall logical arrangement of data storage. In one example, volumes 218(1)-218(n) can include stored user data as one or more files, blocks, or objects that may reside in a hierarchical directory structure within the volumes 218(1)-218(n).

Volumes 218(1)-218(n) are typically configured in formats that may be associated with particular storage systems, and respective volume formats typically comprise features that provide functionality to the volumes 218(1)-218(n), such as providing the ability for volumes 218(1)-218(n) to form clusters, among other functionality. Optionally, one or more of the volumes 218(1)-218(n) can be in composite aggregates and can extend between one or more of the data storage nodes 210(1)-210(n) and one or more of the cloud storage node(s) 236 to provide tiered storage, for example, and other arrangements can also be used in other examples.

In one example, to facilitate access to data stored on the disks or other structures of the data storage nodes 210(1)-210(n), a filesystem may be implemented that logically organizes the information as a hierarchical structure of directories and files. In this example, respective files may be implemented as a set of disk blocks of a particular size that are configured to store information, whereas directories may be implemented as specially formatted files in which information about other files and directories are stored.

Data can be stored as files or objects within a physical volume and/or a virtual volume, which can be associated with respective volume identifiers. The physical volumes correspond to at least a portion of physical storage devices, such as the data storage nodes 210(1)-210(n) (e.g., a Redundant Array of Independent (or Inexpensive) Disks (RAID system)) whose address, addressable space, location, etc. does not change. Typically, the location of the physical volumes does not change in that the range of addresses used to access it generally remains constant.

Virtual volumes, in contrast, can be stored over an aggregate of disparate portions of different physical storage devices. Virtual volumes may be a collection of different available portions of different physical storage device locations, such as some available space from disks, for example. It will be appreciated that since the virtual volumes are not “tied” to any one particular storage device, virtual volumes can be said to include a layer of abstraction or virtualization, which allows it to be resized and/or flexible in some regards.

Further, virtual volumes can include one or more LUNs, directories, Qtrees, files, and/or other storage objects, for example. Among other things, these features, but more particularly the LUNs, allow the disparate memory locations within which data is stored to be identified, for example, and grouped as data storage unit. As such, the LUNs may be characterized as constituting a virtual disk or drive upon which data within the virtual volumes is stored within an aggregate. For example, LUNs are often referred to as virtual drives, such that they emulate a hard drive, while they actually comprise data blocks stored in various parts of a volume.

In one example, the data storage nodes 210(1)-210(n) can have one or more physical ports, wherein each physical port can be assigned a target address (e.g., SCSI target address). To represent respective volumes, a target address on the data storage nodes 210(1)-210(n) can be used to identify one or more of the LUNs. Thus, for example, when one of the node computing devices 206(1)-206(n) connects to a volume, a connection between the one of the node computing devices 206(1)-206(n) and one or more of the LUNs underlying the volume is created.

Respective target addresses can identify multiple of the LUNs, such that a target address can represent multiple volumes. The I/O interface, which can be implemented as circuitry and/or software in a storage adapter or as executable code residing in memory and executed by a processor, for example, can connect to volumes by using one or more addresses that identify the one or more of the LUNs.

The present embodiments may be implemented using hardware, software, firmware, or a combination thereof. Accordingly, it is understood that any operation of the computing systems of the computing environment 100, the network environment 200, or both may be implemented by a computing system using corresponding instructions stored on or in a non-transitory computer-readable medium accessible by a processing system. For the purposes of this description, a tangible computer-usable or computer-readable medium can be any apparatus that can store the program for use by or in connection with the instruction execution system, apparatus, or device. The medium may include non-volatile memory including magnetic storage, solid-state storage, optical storage, cache memory, and RAM.

### III. Exemplary Architecture for Write-Back Caching

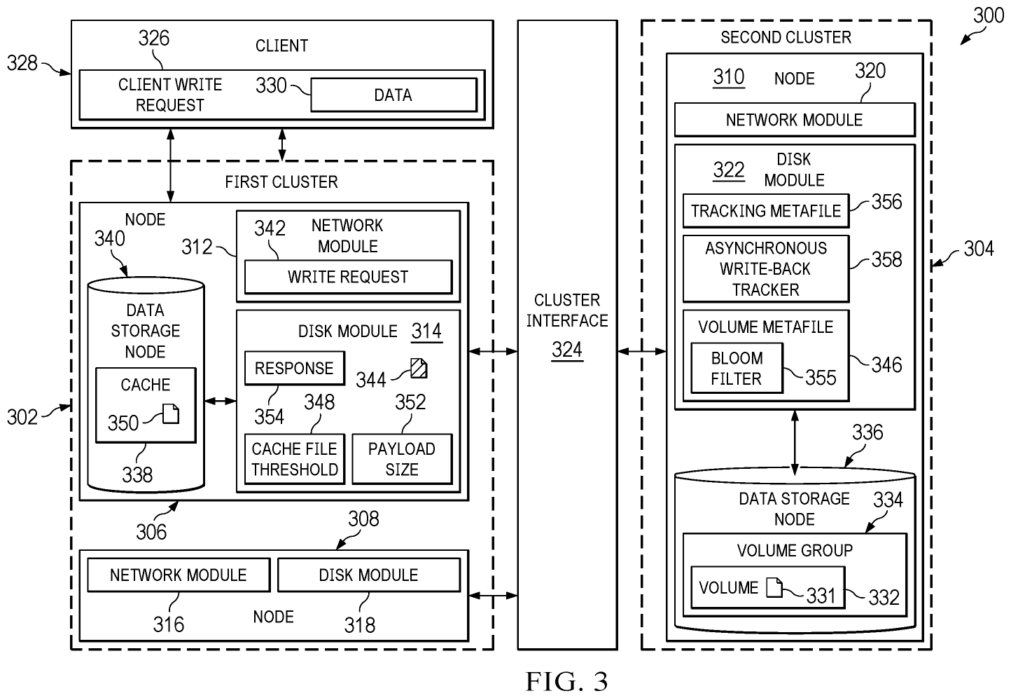

FIG. 3 is a schematic block diagram illustrating a cluster network 300 in accordance with one or more example embodiments. The cluster network 300 may be one example of an implementation for network environment 200 in FIG. 2 and further illustrates another architecture for the principles described above with respect to FIG. 1. The cluster network 300 includes a plurality of clusters that includes, for example, a first cluster 302 and a second cluster 304. Each of these clusters may be implemented in a manner similar to the clusters described with respect to FIG. 1. For example, each of the first cluster 302 and the second cluster 304 may be implemented in a manner similar to cluster 136, cluster 138, or another cluster in the computing environment 100 in FIG. 1.

Each of these clusters may include one or more nodes. In one or more embodiments, the first cluster 302 includes node 306 and the second cluster 304 includes node 308 and node 310. These nodes may be implemented in a manner similar to the nodes described with respect to FIG. 1 (e.g., the first node 130, the second node 132, the third node 134, etc.). In one or more embodiments, each of node 306, node 308, and node 310 may be examples of implementations for the node computing devices 206(1)-206(n) in FIG. 2.

Node 306, node 308, and node 310 may each include a network module, a disk module, or both. In one or more embodiments, node 306 includes a network module 312 and a disk module 314; node 308 includes a network module 316 and a disk module 318; and node 310 includes a network module 320 and disk module 322.

Each of network module 312, network module 316, and network module 320 enables communication with one or more clients via network connections (e.g., network connections 212(1)-212(n) described with respect to FIG. 2). Further, each of network module 312, network module 316, and network module 320 can communicate with the disk module of its same node or the disk module of one or more other nodes in its own cluster over a cluster interface 324. For example, network module 316 may be capable of communicating with disk module 318 and with disk module 322. Cluster interface 324 may include one example of an implementation for cluster fabric 204 in FIG. 2. In one or more embodiments, cluster interface 324 may use one or more logical interfaces to establish connections between the nodes within a cluster, connections between the nodes in different clusters, or both. Cluster interface 324 may be also referred to as a cluster interconnect or a cluster switch.

In some cases, cluster interface 324 may include one or more separate intracluster interfaces for communications between nodes of the same cluster in addition to a main intercluster interface. Each of these various intracluster interfaces may include any number of logical interfaces that allow communications between the nodes of the corresponding cluster. For example, each of the first cluster 302 and the second cluster 304 may have a separate intracluster interface within cluster interface 324. In some cases, this separate intracluster interface may be considered part of the cluster with which it is associated.

In one or more embodiments, a client write request 326 is received at the first cluster 302 (e.g., over a network such as network 126 in FIG. 1). The client write request 326 is a request that originates from a client 328 to write data 330 to a selected file 331 of a volume 332. For example, the client 328 may be given access to the contents of the volume 332. The client 328 may be able to select which of the files in the volume 332 that will be the selected file 331 to which data 330 is written.

The volume 332 may be stored on data storage node 336, which is one example of an implementation for one of data storage nodes 210(1)-210(n). The volume 332 may be one example of an implementation for one of volumes 218(1)-218(n). Node 306 provides access to the data stored on volume 332. The selected file 331 may be, for example, a file of a write-anywhere-file-layout file system. In one or more embodiments, the data storage node 336 is managed by node 310 in the second cluster 304. For example, node 310 provides access to the data storage node 336 and thereby the volume 332.

The volume 332 is associated with a corresponding cache 338. This cache 338 may correspond to volume 332 by being associated one-to-one with volume 332 or by being associated with volume group 334 that includes volume 332. The cache 338 provides a temporary storage location that is located between the client 328 and a data storage node 336. In the read context, the cache 338 may reduce read latency by allowing data to be served faster than would be otherwise possible by fetching the data directly from the source, the volume 332 on the data storage node 336. In the write context, the cache 338 may reduce write latency by allowing the writing of data to be completed and confirmed to the client 328 faster than directly writing the data to the volume 332.

The client 328 may mount the volume 332 (or the volume group 334 that includes the volume 332) or cache 338 depending on the needs of the client 328. For example, the client 328 may be located remotely with respect to the data storage node 336 and may mount the cache 338 to reduce overall read and/or write latency and increase overall throughput. In one or more examples, the client 328 determines which of the cache 338 or the volume 332 is “closer” to the client 328 and mounts the one that is closer. The “closer” of the volume 332 or the cache 338 may mount be the one that is physically located closer to the client 328 than the data storage node 336, the one that has a shorter data transmission time from the client 328 to it, or the one that belongs to a cluster that is closer to the client 328 than the cluster to which the other belongs.

In some cases, the client 328 is unaware of whether the volume 332 or the cache 338 has been mounted. For example, the client 328 may simply see that the files and folders of the volume 332 are available for reading or writing. In other cases, the client 328 may be allowed to select the cache 338 or the volume 332 for mounting. The client write request 326 identifies whether the cache 338 or the volume 332 (or the volume group 334) has been mounted to the client 328.

The cache 338 may be stored on a data storage node 340, which is one example of an implementation for one of data storage nodes 210(1)-210(n). The cache 338 may be hosted by for example, node 306. More specifically, the cache 338 may be hosted by the disk module 314 of the node 306. In other words, the disk module 314 provides access to the data storage node 340, and thereby the cache 338.

In one or more embodiments, the client write request 326 is received by the network module 312 of node 306. In response to receiving the client write request 326 from the client 328, the network module 312 determines whether the operation is for the volume 332 or the cache 338 based on the information included in the client write request 326. The network module 312 processes the client write request 326 to form a write request 342 that can be sent out to the disk module 314. This write request 342 is generated in a format that can be readily processed by the disk module 314 or any other disk module of a node in the cluster network 300.

In one or more embodiments, the network module 312 may send out a query to determine whether the underlying volume 332 to which the write is to occur is write-back enabled. For example, a persistent RAID level write-back flag may be set on the volume 332. When the volume 332 is part of the volume group 334, the persistent RAID level write-back flag may be set on each of the volumes included in the volume group 334. If the network module 312 determines that the underlying volume 332 is not write-back enabled, the network module 312 forwards the write request 342 to the disk module 322 at the node 310 hosting the volume 332. The data 330 is then directly written to the volume 332 without first being written to cache 338.

If, however, the network module 312 determines that the underlying volume 332 is write-back enabled, the network module 312 forwards the write request 342 to the disk module 314 of node 306 hosting the cache 338. The disk module 314 determines whether the cache 338 has an active (not revoked) write delegation for the selected file 331 identified in the write request 342. A write delegation prevents other processes (e.g., other processes operating within node 306, other client processes operating at the client 328 or another client, other processes operating at a different node in the first cluster 302, and other processes operating at a different cluster (e.g., second cluster 304)) from at least writing to the selected file 331 until the write delegation of the cache 338 is revoked. This write delegation may be the write portion of a read-write delegation. A read-write delegation prevents other processes reading from and writing to the cache 338 until the read-write delegation has been revoked. In some cases, a write delegation may be a delegation separate from a read delegation. A write delegation for the selected file 331 may be revoked when a client process or other process attempts to access the same selected file 331.

The statuses of write delegations (and/or read-write delegations) are tracked in a cache metafile 344. For example, the cache metafile 344 may track when a write delegation has been granted and when a write delegation has been revoked. In some cases, the cache metafile 344 may simply track any write delegation that has been granted to the cache 338 and that is active (not revoked). The disk module 314 determines whether the cache 338 has the active write delegation for the selected file 331 based on the information in the cache metafile 344.

If the cache 338 does not have an active write delegation for the selected file 331, the disk module 314 requests the write delegation for the selected file 331 to allow the cache 338 exclusive access to the selected file 331. This request is sent to the disk module 322 of the node 310 that is hosting the volume 332 over the cluster interface 324. The disk module 322 processes the delegation request, grants the request, and generates an entry in its volume metafile 346. The volume metafile 346 may correspond to the volume 332 or to the volume group 334. The volume metafile 346 is used to track which caches have been granted write delegations (and/or read-write delegations). The disk module 322 of node 310 sends a response back to the disk module 314 of node 306 indicating that the write delegation has been granted.

Once the disk module 314 has obtained the write delegation, the cache 338 determines whether processing the write request 342 will cause a cache file threshold 348 to be met (e.g., reached or exceeded) for an amount of accumulated data in a cache file 350 in the cache 338 that corresponds to the selected file 331. The cache file threshold 348 for the amount of accumulated data in the cache file 350 may be set to allow multiple write requests for the selected file 331 to be processed before a write-back of the accumulated data in the cache file 350 is initiated. In one or more embodiments, the cache file threshold 348 is set to a value between 64 kilobytes and 10 gigabytes. For example, the cache file threshold 348 may be set to a value of 1, 2, 3, 4, 5, 6, 7, 8, 9, or 10 gigabytes. In some cases, the cache file threshold 348 is set to a default value (e.g., 500 kilobytes, 800 kilobytes, 1 megabytes, 5 megabytes, etc.). In other embodiments, the cache file threshold 348 is set to a value between 1 gigabyte and 110 gigabytes. In some cases, the cache file threshold 348 may be set to a percentage of the overall size of cache file 350.

In one or more embodiments, a network administrator may adjust the cache file threshold 348 based on performance requirements for the workloads managed by the network administrator. For example, a network administrator, being unable to predict the size of the write requests that will be received, may set the cache file threshold 348 for the amount of accumulated data to a value that is just greater than (e.g., a value within a selected number of data blocks, bytes, kilobytes, etc. of) the maximum file size that can be written. In some embodiments, the maximum file size may also be tunable by the network administrator. In one or more embodiments, a network administrator may adjust the cache file threshold 348 based on performance requirements for the workloads managed by the network administrator. A network administrator may adjust the cache file threshold 348 based on different expected workloads such that different, typical workloads can have different recommended threshold. In some cases, the cache file threshold 348 may be set (e.g., automatically or by the network administrator) based on observed workloads over time. In In one or more embodiments, the cache file threshold 348 may be set or adjusted automatically (e.g., by the disk module 314) based on observed workloads, performance requirements, one or more predefined rules, one or more criteria being met, or a combination thereof.

The disk module 314 determines whether the cache file threshold 348 has been met by consulting the cache metafile 344. The cache metafile 344 may track, for example, without limitation, the amount of accumulated data in the cache file 350, the amount of accumulated data in the cache 338, the amount of time that has been elapsed since a modification (e.g., write) has occurred for each cache file in the cache 338, or a combination thereof. In one or more embodiments, the amount of time that has been elapsed since a modification (e.g., write) has occurred for each cache file in the cache 338 is stored in the inode associated with the cache file.

If the cache file threshold 348 has not been met, the disk module 314 processes the write and the data 330 is written to the cache file 350. The disk module 314 stores information about the write in the cache metafile 344. For example, the size of the write may be tracked via the cache metafile 344. The time at which the data 330 is written to the cache file 350 may be tracked using the inode associated with the cache.

If, however, the cache file threshold 348 will be met, the disk module 314 initiates a write-back of the accumulated data in the cache file 350 to the selected file 331 on the volume 332. Once the write-back has been completed, the disk module 314 is free to process the write request 342 as described above.

During a write-back initiated based on the cache file threshold 348 being met, the disk module 314 flushes the cache file 350. The write-back operation is performed by sending write-back messages to the disk module 322 on node 310 hosting the volume 332. The payload size 352 of these write-back messages may be a tunable parameter specific to the cache 338. For example, to reduce write-back chatter between the disk module 314 and the disk module 322, the payload size 352 may be increased to allow for data to be transmitted from the cache 338 via disk module 314 to the volume 332 via disk module 322. In one or more embodiments, the payload size 352 is set to a value between 64 kilobytes (e.g., 16 data blocks) and 960 kilobytes (240 blocks). In other embodiments, the payload size 352 is set to a value between 64 kilobytes (e.g., 16 data blocks) and 100 megabytes (e.g., 25,000 data blocks). In some examples, the payload size 352 is set to a default value (e.g., 500 kilobytes, 800 kilobytes, 1000 kilobytes, 1200 kilobytes, 2 megabytes, etc.). In some cases, the minimum for the payload size 352 is the minimum possible size of a write request that can received at the disk module 314.

In one or more embodiments, the cache file threshold 348, the payload size 352, or both are stored as properties of the underlying volume 332. For example, the cache file threshold 348, the payload size 352, or both may be stored as RAID level properties for the underlying volume 332. In other embodiments, the cache file threshold 348, the payload size 352, or both may be stored in the cache metafile 344. In some embodiments, the cache file threshold 348, the payload size 352, or both may be stored in a separate file managed by disk module 314.

After the data 330 has been written to the cache 338, the disk module 314 generates and sends a response 354 to the client 328 via the network module 312. The response confirms that the write has been completed. Using cache 338 reduces the write latency, which may be, for example, the time between when the client write request 326 was received from the client 328 and when the response 354 is sent to the client 328. Further, using cache 338 increases throughput.

In one or more embodiments, disk module 322 may use bloom filter 355 to track the individual blocks of cache 338 that have been modified during a write. Data that is inserted into bloom filter 355 is not deleted. In some cases, bloom filter 355 is implemented as part of volume metafile 346. Bloom filter 355 allows for sequential or serial tracking of data that is written and written back. Further, bloom filter 355 may have a probabilistic data structure such that a query about which blocks of a cache file (e.g., cache file 350) have been modified and need to be written back could lead to false positives.

In certain cases, it may be desirable to perform asynchronous write-back in which multiple write-back operations can happen in parallel and/or in which a write-back operation does not interfere with a write operation (e.g., writing data to the cache file). For example, write-back operations from some blocks of cache file 350 can be written back while other blocks of cache file 350 may be written to as part of handling write request 342. In such cases, tracking metafile 356 can be used to track which individual blocks of the cache 338 have been modified (e.g., by being newly written to, by having existing data modified, or being otherwise “dirtied”).

Tracking metafile 356 may be one tracking metafile of a set of tracking metafiles, each of which corresponds to a different cache and thereby, a different volume. For example, tracking metafile 356 corresponds to cache 338, which corresponds to volume 332. Tracking metafile 356 may be created, for example, upon the enabling of write-back operations for cache 338.

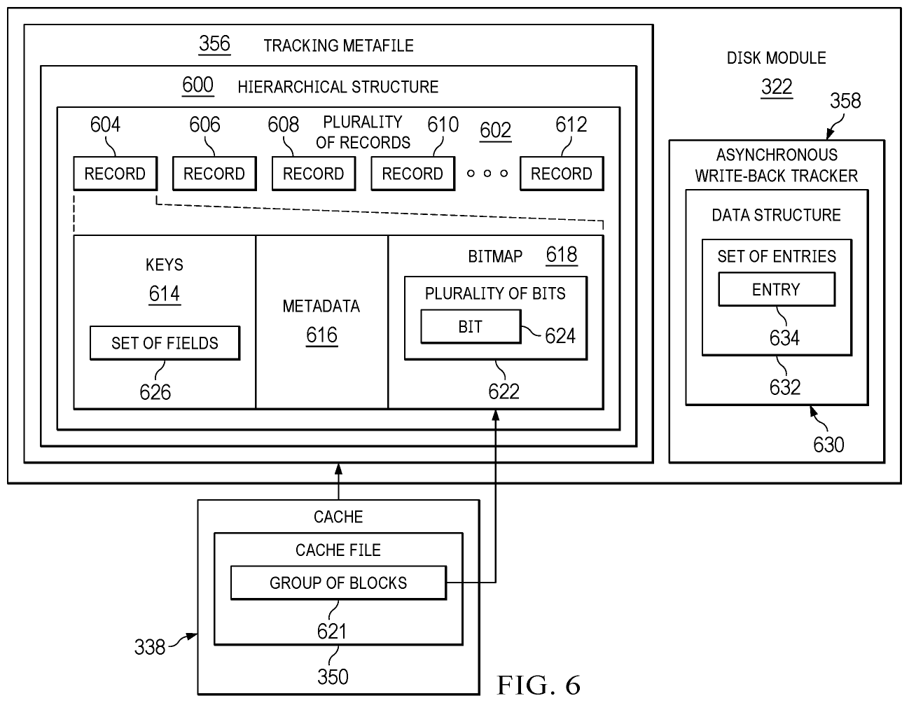

Tracking metafile 356 may be implemented in different ways. In one or more embodiments, tracking metafile 356 is implemented as metafile with a private inode number. Tracking metafile 356 may have a tree or tree-like structure with multiple records, each record corresponding to a portion (e.g., a sequence of blocks) of a cache file. For example, tracking metafile 356 may be implemented using a vplus tree structure. An example implementation for tracking metafile 356 is described below in further detail with respect to FIG. 6.

Additionally, disk module 322 may use asynchronous write-back tracker 358 to track the asynchronous write-backs that are in progress. For example, asynchronous write-back tracker 358 may be used to track any write-backs that have been initiated in response to the records in tracking metafile 356 being filled (or “full”). An example implementation for asynchronous write-back tracker 358 is described below in further detail with respect to FIG. 6.

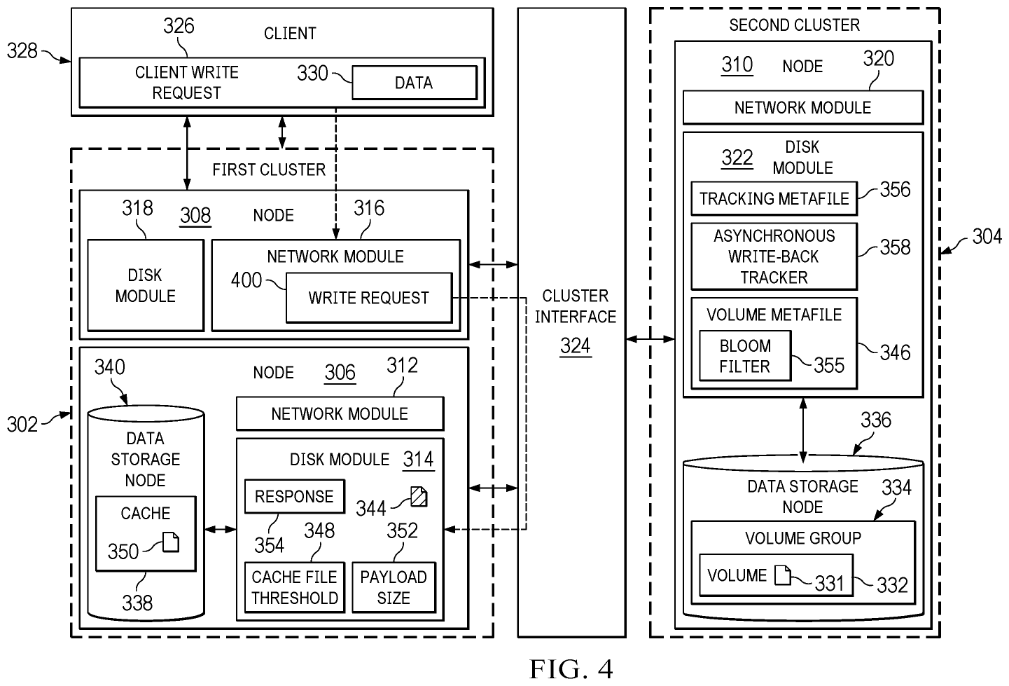

FIG. 4 is another schematic block diagram for the cluster network 300 from FIG. 3 in which the client write request is received by a different node in accordance with one or more example embodiments. In FIG. 4, the client write request 326 is received by the network module 316 of node 306. In response to receiving the client write request 326 from the client 328, the network module 316 processes the client write request 326 to form a write request 400. This write request 400, similar to the write request 342 generated in FIG. 3, is generated in a format that can be readily processed by any of the disk modules in the nodes of cluster network 300. The network module 316 may identify, for example, that the operation is for the cache 338 that is being hosted by node 306. The network module 316 sends the write request 500 to the disk module 314 of node 306. The disk module 314 then processes the write request 500 in a manner similar to that described for the write request 342 in FIG. 2.

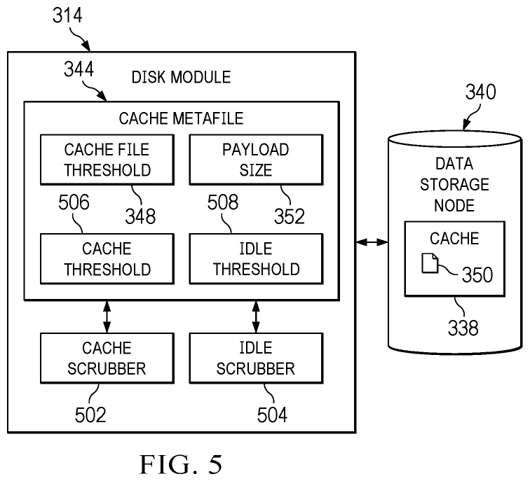

FIG. 5 is a schematic block diagram of the disk module 314 of node 306 from FIGS. 3-4 described in greater detail in accordance with one or more example embodiments. The disk module 314 may include a cache scrubber 502 and an idle scrubber 504. Each of these scrubbers may be implemented using hardware, software, or a combination thereof. Each of these scrubbers may be implemented using one or more processes operating within the disk module 314.

The cache scrubber 502 uses the cache metafile 344 to track the total amount of data being stored in the cache 338 as a result of reads and writes. The cache scrubber 502 determines whether a cache threshold 506 for the amount of accumulated data in the cache 338 has been met (e.g., reached or exceeded). The cache threshold 506 for the amount of accumulated data in the cache 338 may be set to ensure that the cache 338 does not end up with an overly large amount of data that has yet to be written back. This type of accumulation may happen, for instance, when individual writes are smaller than the cache file threshold 348 described above with respect to FIGS. 3-4. In one or more embodiments, the cache threshold 506 may be set to a value between 1 megabyte and 10 terabytes. For example, the cache threshold 506 may be set to a value of 1 megabyte, 10 megabytes, 100 megabytes, 1 gigabyte, 10 gigabytes, 100 gigabytes, 1 terabyte, 10 terabytes, or some other number. In some cases, the cache threshold may be set to a default value (e.g., 6 gigabytes, 8 gigabytes, 10 gigabytes, etc.). The cache threshold 506 may be set in units of bytes (e.g., megabytes, gigabytes, terabytes, etc.) or data blocks. In one or more embodiments, cache threshold 506 is set to a value that is smaller than cache file threshold 348 to ensure that the operation of cache scrubber 502 does not interfere with operations being performed based on cache file threshold 348. In some cases, the cache threshold 506 may be set to a percentage of the overall size of the cache 338.

In response to determining that the cache threshold 506 for the amount of accumulated data in the cache 338 has been met, the cache scrubber 502 initiates a write-back of the accumulated data in the cache 338. In one or more embodiments, the cache scrubber 502 initiates a write-back of all entries in the cache 338. In other embodiments, the cache scrubber 502 initiates a write-back of a selected portion of the cache 338 (e.g., the cache files with the oldest write times).

The idle scrubber 504 is set to determine whether any cache files have been idle for at least a selected idle threshold 508. The idle threshold 508 may be a threshold for an amount of time that a cache file (e.g., cache file 350 in FIGS. 3-4) has been left idle. A cache file is considered idle when it is not being modified. For example, a cache file is idle when no data is being written to that cache file. The idle threshold 508 may be set to a value between, for example, 30 seconds and 10 minutes. In some cases, the idle threshold 508 may be set to a default value (e.g., 1 minute, 2 minutes, 3 minutes, 5 minutes, etc.). The idle scrubber 504 may use the cache metafile 344 to determine the idle times for the cache files in the cache 338.

If the idle scrubber 504 determines that one or more cache files in the cache 338 have met the idle threshold 508, these cache files are then flushed. In particular, the idle scrubber 504 initiates a write-back of the accumulated data in these particular cache files. In some embodiments, the idle scrubber 504 is set to make its determination at a selected interval 510. The selected interval may be, for example, a value between 1 minute and 30 minutes. The selected interval may be set to a default value (e.g., 2 minutes, 3 minutes, 5 minutes, 8 minutes, etc.).

In some embodiments, the cache scrubber 502, the idle scrubber 504, or both may be permitted to run on-demand. For example, the disk module 314 can send a command to trigger the cache scrubber 502 to flush out all entries of the cache 338. As another example, the disk module 314 can send a command to trigger the idle scrubber 504 to flush out any cache files that have met the idle threshold 508. In one or more embodiments, the cache scrubber 502, the idle scrubber 504, or both may be implemented as processes (e.g., programming threads) inside the file system. In other embodiments, the cache scrubber 502, the idle scrubber 504, or both may be implemented as processes (e.g., programming threads) outside the file system. For example, the idle scrubber 504 may be implemented as a process outside the file system (e.g., via a management host with the process running parallel to the file system). In some cases, implementing the idle scrubber 504, the cache scrubber 502, or both outside the file system may reduce the amount of computing resources used, improve scheduling capabilities, or both.

The cache threshold 506 and the idle threshold 508 may be tunable parameters. In one or more embodiments, a network administrator may adjust these thresholds based on performance requirements for the workloads managed by the network administrator. A network administrator may adjust the thresholds based on different expected workloads such that different, typical workloads can have different recommended thresholds. In some cases, these thresholds may be set (e.g., by the network administrator or automatically) based on observed workloads over time. In one or more embodiments, the thresholds may be set or changed automatically based on observed workloads, performance requirements, one or more predefined rules, one or more criteria being met, or a combination thereof.

In one or more embodiments, the cache file threshold 348, the payload size 352, the cache threshold 506, the idle threshold 508, or a combination thereof are stored as properties of the underlying volume 332. For example, the cache file threshold 348, the payload size 352, the cache threshold 506, the idle threshold 508, or a combination thereof may be stored as RAID level properties for the underlying volume 332.

In other embodiments, the cache file threshold 348, the payload size 352, the cache threshold 506, the idle threshold 508, or a combination thereof are stored in cache metafile 344. In some embodiments, the cache file threshold 348, the payload size 352, the cache threshold 506, the idle threshold 508, or a combination thereof are stored in a separate file or metafile managed by disk module 314. In other embodiments, the cache file threshold 348, the payload size 352, the cache threshold 506, the idle threshold 508, or a combination thereof are stored in one or more separate files in data storage node 340. Thus, each of the cache file threshold 348, the payload size 352, the cache threshold 506, and the idle threshold 508 may be independently stored in different ways for use by the disk module 314.

The description of computing environment in FIGS. 1-3 are not meant to imply physical or architectural limitations to the manner in which the various embodiments described herein may be implemented. Other components in addition to or in place of the ones illustrated may be used. Some components may be optional.

Further, the functionalities described above with respect to network module 312 and disk module 314 in FIG. 3 may be similarly applicable to network module 316 and disk module 318, respectively, and to network module 320 and disk module 322, respectively. For example, disk module 322 may be able to perform write-back caching functions in a manner similar to disk module 314.

FIG. 6 is an illustration of one example of a configuration for the tracking metafile 356 and asynchronous write-back tracker 358 from FIGS. 3-4 in accordance with one or more example embodiments. Tracking metafile 356 corresponds to a cache (e.g., cache 338). Tracking metafile 356 tracks the blocks (e.g., file block numbers) of cache 338 that are modified (e.g., by being newly written to, by having existing data modified, or being otherwise “dirtied”). Tracking metafile 356 tracks the modified blocks for the various cache files in cache 338, including cache file 350.

In one or more embodiments, the tracking metafile 356 may be implemented using a hierarchical structure 600. The hierarchical structure 600 may take the form of a tree or tree-like structure, such as, for example, a vplus tree structure. Tracking metafile 356 may have a private inode number.

In one or more embodiments, tracking metafile 346 includes a plurality of records 602 as part of hierarchical structure 600. Each record of plurality of records 602 corresponds to a specific cache file in cache 338. Each record of plurality of records 602 contains at least one key, metadata, and a bitmap for a corresponding set of blocks of the corresponding cache file as the payload. Each record, however, has a limited number of bits. Accordingly, multiple records of plurality of records 602 may correspond to a same specific cache file in cache 338.

For example, plurality of records 602 may include record 604, record 606, record 608, record 610, and record 612. Record 604 may correspond to cache file A; record 606 and record 608 may correspond to cache file B; and record 610 and record 612 may correspond to cache file C.

As one example of an implementation for a record in plurality of records 602, record 604 is shown in an expanded view. Record 604 may correspond to, for example, cache file 350 of cache 338. More specifically, record 604 may correspond to group of blocks 621 in cache file 350. Group of blocks 621 may be, for example, a sequence of blocks (or data blocks) in cache file 350. Group of blocks 621 may be a range of blocks in a sequential order with respect to, for example, file block number.

Record 604 may include key 614, metadata 616, and bitmap 618. Bitmap 618 includes, for, example, a plurality of bits 622 that may take the form of an array of bits. Plurality of bits 622, and thereby record 604, represents group of blocks 621 in cache file 350. Specifically, each bit of the plurality of bits 622 corresponds to at least one different block (e.g., a block indexed by a file block number (fbn or FBN)) in group of blocks 621. Accordingly, a given bit may represent one block of data or multiple blocks of data in group of blocks 621.

Bit 624 is one example of a bit in plurality of bits 622. Bit 624 may represent at least one corresponding block of data in the corresponding cache file. Bit 624 may be associated with the fbn for the block of data. When that block is modified (e.g., by being newly written to, by having existing data modified, or being otherwise “dirtied”), bit 624 is updated to reflect this modification with bit 624 the value of bit 624 being changed to reflect this modification. For example, the value of bit 624 may be changed from “0” to “1” to indicate modification. The value of “0” indicates a bit is “empty” because the corresponding block(s) are unmodified (e.g., in which data has not yet been written to the block represented by bit 624 since the creation of record 604 or in which existing data in the block has not yet been modified since a last write-back operation for the record 604).

The number of bits in bitmap 618, and thereby record 604, may be a configurable (e.g., user-configurable) number. In one or more embodiments, the number may be, 4, 6, 8, 10, 12, 14, 15, 16, 18, 20, 25, 30, 32, or some other number of bits between 1 and 100.

Key 614 includes identifying information for record 604. Key 614 may function as a unique index for record 604. For example, key 614 may include set of fields 626 in which each field includes various types of information relating to record 604. Key 614 may be implemented as a tuple in various embodiments. In other words, key 614 may be hashable and immutable. Key 614 may contain, for example, the corresponding cache file identifier (e.g., fileid), the file block number (fbn or FBN) that maps to the first bit in the bitmap 618, and/or other information. Key 614 may further include a timestamp or a timestamp in association with the file block number (fbn or FBN) that maps to the first bit in the bitmap 618. The timestamp may be, for example, a time at which record 604 was created.

Metadata 616 includes metadata about record 604. In one or more embodiments, metadata 616 includes timestamp information. In other embodiments, metadata 616 may include information about records 604 that can be updated based on changes to record 604. For example, metadata 616 may include information about the number of bits in record 604 that have a value that indicates the corresponding block(s) are modified (e.g., by being newly written to, by having existing data modified, or being otherwise “dirtied”), header information for record 604, timestamp information corresponding to when the values of various bits are changed, various other types of information, or a combination thereof.

Record 606, record 608, record 610, and record 612 may be implemented in a manner similar to the manner described above for record 604. In one or more embodiments, plurality of records 602 fully represents cache 338 such that each block in cache 338 is represented by the bit of a corresponding one of plurality of records 602. For example, tracking metafile 356 may be auto-populated with plurality of records 602 that fully represent cache 338 upon write-back being enabled. Any time that a cache file in cache 338 is updated, the corresponding record(s) in plurality of records 602 is(are) updated.

In one or more embodiments, a record becomes “full” when all bits of that record indicate that the corresponding group of blocks has been modified such that a write-back can take place. The write-back is initiated to write-back the data stored in the group of blocks represented by the record to the volume 332. Once the write-back of the record has been completed, tracking metafile 356 is updated to indicate that the write-back has been completed.

For example, tracking metafile 356 may be updated by deleting the record from tracking metafile 356 after completion of the write-back. A similar record for the same group of blocks represented by the deleted record may be added back to tracking metafile 356 the next time data is written to that group of blocks in cache 338. In another example, tracking metafile 356 may be updated by changing the values of all bits in the record to reflect an “unmodified” or “empty” state indicating that the corresponding group of blocks is available for writes. For example, all “1” values in the bitmap (e.g., bitmap 618) may be changed to “0” values.

Asynchronous write-back tracker 358 is used to track asynchronous write-backs that are in progress. Asynchronous write-back tracker 358 may be implemented in different ways. In one or more embodiments, asynchronous write-back tracker 358 includes at least one data structure 630. Data structure 630 may be implemented as, for example, a hash data structure. Data structure 630 may include, for example, a set of entries 632. For example, data structure 630 may be a hash table and plurality of entries 632 may be keys in the hash table that are used to track the file block numbers that are undergoing a write-back operation.

When a write-back of the data associated with a record is triggered, an entry is added to set of entries 632. This entry may be added before, concurrently with, or just after the write-back is initiated. Each entry of plurality of entries 632 corresponds to a different record of tracking metafile 356. For example, when a write-back of the data associated with record 604 is triggered, a corresponding entry (e.g., entry 634) is added to data structure 630. Entry 634 includes, for example, a local file system identifier (fsid), a cache identifier (e.g., an identifier for the cache file corresponding to record 604), and a list of the file block numbers that correspond to record 604 (e.g., a list of the modified (“dirtied”) sequence of fons represented by plurality of bits 622 in record 604).

Accordingly, whenever a write request arrives to write to a particular file block number of the cache file corresponding to record 604, asynchronous write-back tracker 358 is checked to see whether that particular file block number is included in data structure 630. The presence of entry 634 indicates that the file block number is undergoing a write-back operation and the write should be retried-later and indeed, the write is retried at a later point in time. In this manner, data loss that might otherwise occur due to concurrent writes and write-backs may be prevented.

After the write-back has been completed, the entry is removed from data structure 630 to indicate that the group of blocks corresponding to record 604 may be written to without interfering with an ongoing write-back. In this manner, set of entries 632 in data structure 630 are used to indicate which blocks in cache 338 are not available for writes. Blocks with file block numbers that are not represented in set of entries 632 may be freely written to in response to write requests.

### IV. Exemplary Methodologies for Write-Back Caching

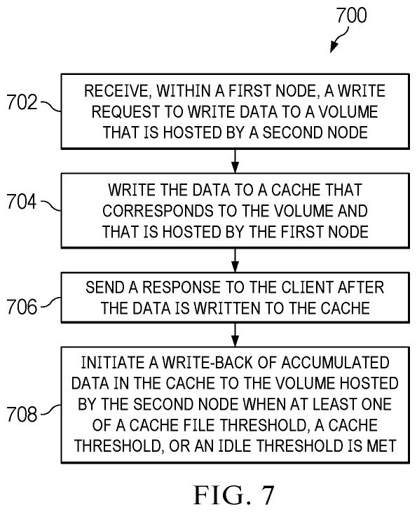

FIG. 7 is a flow diagram of a process 700 for write-back caching in accordance with one or more example embodiments. The process 700 may be implemented by one or more processors executing computer-readable instructions (e.g., from one or more computer-readable media) to perform the functions described herein. The process 700 may be implemented using one or more processors in a node in a cluster such as, for example, first node 130, second node 132, or third node 134 in FIG. 1. In some cases, the process 700 may be implemented by one or more processors of a data storage apparatus, such as, for example, one of the data storage apparatuses 202(1)-202(n) described in connection with FIG. 2. In one or more embodiments, the process 700 may be implemented by one or more processors of a node such as, for example, node 306 in FIGS. 3-4. Further, the process 700 may be implemented by, for example, disk module 314 in FIGS. 3-5, disk module 318 in FIGS. 3-4, and/or disk module 322 in FIGS. 3-4.

Operation 702 includes receiving, within a first node, a write request to write data to a volume that is hosted by a second node. In one or more embodiments, the first node is in a first cluster and the second node is in a second cluster that is different from the first cluster. In other embodiments, the first node and the second node belong to the same cluster. The first node may be, for example, node 306 in FIGS. 3-4. The second node may be, for example, node 310 in FIGS. 3-4 (or alternatively, node 308 in FIGS. 3-4).

The write request originates from a client. For example, the write request may be a modified (or transformed) version of a client write request that originates from the client. The client may be, for example, client 328 in FIGS. 3-4. In some embodiments, the client write request is received from the client at a network module of a node. This node may be the first node or a different node. The network module processes the client write request to generate the write request, which is then sent to the disk module of the first node. This write request may be, for example, write request 342 in FIG. 3 or write request 400 in FIG. 4. The disk module may be, for example, disk module 314 in FIGS. 3-5.

In one or more embodiments, the write request may be a request to write data to one or more selected files on the volume. For example, the write request may be to write a discrete amount of data to a selected on the volume. The selected file and volume may be, for example, the selected file 331 and the volume 332, respectively, in FIGS. 3-4. In one or more embodiments, the client selects the file from the volume for writing data without being aware of whether the volume or its corresponding cache has been mounted to the client. In some embodiments, the client may be aware of whether the volume or the corresponding cache is mounted but the volume contents are presented to the client in the same way regardless of which is mounted.

Operation 704 includes writing the data to a cache that corresponds to the volume and that is hosted by the first node. The data is written in data blocks of the cache. In one or more embodiments, the data is written to a cache file in the cache that corresponds to the selected file. The cache file may correspond to the selected file to the selected file by being designated for storing portions of data to be read from or written to the selected file with reduced read latency or write latency, respectively. For example, data that is written to the cache file is designated for being written to the selected file.

Operation 706 includes sending a response to the client after the data is written to the cache. The response confirms that the write operation has been completed. Writing the data to the cache prior to the data being written to the volume reduces the write latency associated with the write request because the overall time it takes to the write the data to the cache is less than the overall time it takes to write the data directly to the volume. Further, the time it takes to confirm that the write has been completed is reduced.

Operation 708 includes initiating a write-back of accumulated data in the cache to the volume hosted by the second node when at least one of a cache file threshold, a cache threshold, or an idle threshold is met. The write-back includes writing the accumulated data in the cache to the volume and flushing the accumulated data that has been written back from the cache. Initiating the write-back may include, for example, without limitation, generating and sending a command to begin writing the accumulated data in the cache to the volume, beginning the writing back of the accumulated data in the cache to the volume, or both.

The writing of the accumulated data from the cache to the volume may be performed in various ways. For example, in operation 708, some or all of the accumulated data in the cache may be written back to the volume hosted by the second node. In one or more embodiments, the write-back may occur in two or more stages. In some embodiments, the write-back may include writing all accumulated data in the cache file to the volume and optionally, some or all of other the accumulated data in the cache to the volume. In some cases, the write-back may include writing accumulated data that is in the cache but not in the cache file to the volume (e.g., where the cache threshold has been met but the cache file threshold has not been met). The write-back may include writing back to the volume, for example, the oldest data in the cache or data that was written in the cache prior to a selected time. This selected time may be, for example, without limitation, 30 seconds, 1 minute, 2 minutes, 3 minutes, 4 minutes, 5 minutes, 11 minutes, 20 minutes, or some other amount of time between 15 seconds and 1 hour prior to the current write operation.

The cache file threshold, the cache threshold, and the idle threshold may be, for example, the cache file threshold 348 in FIGS. 3-5, the cache threshold 506 in FIG. 5, and the idle threshold 508 in FIG. 5, respectively. The cache file threshold for the amount of accumulated data in the cache file may be set to allow multiple write requests for the selected file to be processed before a write-back of the accumulated data in the cache file is initiated. In one or more embodiments, the cache file threshold is set to a value between 64 kilobytes and 10 gigabytes. For example, the cache file threshold may be set to a value of 1, 2, 3, 4, 5, 6, 7, 8, 9, or 10 gigabytes. In some cases, the cache file threshold is set to a default value (e.g., 500 kilobytes, 800 kilobytes, 1 megabytes, 5 megabytes, etc.). In some cases, the cache file threshold may be set to a percentage of the overall size of the cache file.

The cache threshold for the amount of accumulated data in the cache may be set to ensure that the cache does not end up with an overly large amount of data that has yet to be written back. This type of accumulation may happen, for instance, when individual writes are smaller than the cache file threshold. In one or more embodiments, the cache threshold may be set to a value between 1 megabyte and 10 terabytes. For example, the cache threshold may be set to a value of 1 megabyte, 10 megabytes, 100 megabytes, 1 gigabyte, 10 gigabytes, 100 gigabytes, 1 terabyte, 10 terabytes, or some other number. In some cases, the cache threshold may be set to a default value (e.g., 6 gigabytes, 8 gigabytes, 10 gigabytes, etc.). The cache threshold may be set in units of bytes (e.g., megabytes, gigabytes, terabytes, etc.) or data blocks. In some cases, the cache threshold may be set to a percentage of the overall size of the cache.

The idle threshold may be a threshold for an amount of time that a cache file has been left idle. A cache file is considered idle when it is not being modified. For example, a cache file is idle when no data is being written to that cache file. The idle threshold may be set to a value between, for example, 30 seconds and 10 minutes. In some cases, the idle threshold may be set to a default value (e.g., 1 minute, 2 minutes, 3 minutes, 5 minutes, etc.).

The cache file threshold, the cache threshold, and the idle threshold may be tunable parameters. For example, a network administrator may adjust these thresholds based on performance requirements for the workloads managed by the network administrator. A network administrator may adjust the thresholds based on different expected workloads such that different, typical workloads can have different recommended thresholds. In some cases, these thresholds may be set (e.g., by the network administrator or automatically) based on observed workloads over time. In one or more embodiments, these threshold may be set or adjusted automatically based on observed workloads, performance requirements, one or more predefined rules, one or more criteria being met, or a combination thereof.

In one or more embodiments, a network administrator may adjust the cache file threshold based on performance requirements for the workloads managed by the network administrator. For example, a network administrator, being unable to predict the size of the write requests that will be received, may set the cache file threshold for the amount of accumulated data to a value that is just greater than (e.g., a value within a selected number of data blocks, bytes, kilobytes, etc. of) the maximum file size that can be written. For example, if the maximum file size is 1000 kilobytes, the cache file threshold may be set to 1200 kilobytes.

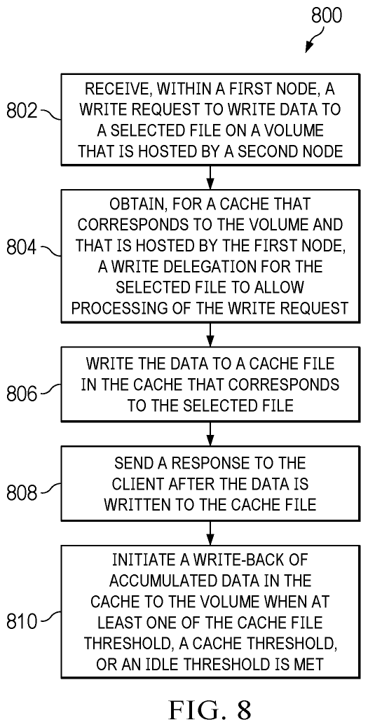

FIG. 8 is a flow diagram of a process 800 for write-back caching in accordance with one or more example embodiments. The process 800 may be implemented by one or more processors executing computer-readable instructions (e.g., from one or more computer-readable media) to perform the functions described herein. The process 800 may be implemented using one or more processors in a node in a cluster such as, for example, first node 130, second node 132, or third node 134 in FIG. 1. In some cases, the process 800 may be implemented by one or more processors of a data storage apparatus, such as, for example, one of the data storage apparatuses 202(1)-202(n) described in connection with FIG. 2. In one or more embodiments, the process 800 may be implemented by one or more processors of a node such as, for example, node 306 in FIGS. 3-4. Further, the process 800 may be implemented by, for example, disk module 314 in FIGS. 3-5, disk module 318 in FIGS. 3-4, and/or disk module 322 in FIGS. 3-4.

Operation 802 includes receiving, within a first node, a write request to write data to a selected file on a volume that is hosted by a second node. In one or more embodiments, the first node is in a first cluster and the second node is in a second cluster that is different from the first cluster. In other embodiments, the first node and the second node belong to the same cluster. The first node may be, for example, node 306 in FIGS. 3-4. The second node may be, for example, node 310 in FIGS. 3-4 (or alternatively, node 308 in FIGS. 3-4).

The write request originates from a client. For example, the write request may be a modified (or transformed) version of a client write request that originates from the client. The client may be, for example, client 328 in FIGS. 3-4. In some embodiments, the client write request is received from the client at a network module of a node. This node may be the first node or a different node. The network module processes the client write request to generate the write request, which is then sent to the disk module of the first node. This write request may be, for example, write request 342 in FIG. 3 or write request 400 in FIG. 4. The disk module may be, for example, disk module 314 in FIGS. 3-5.

In operation 802, the selected file and volume may be, for example, the selected file 331 and the volume 332, respectively, in FIGS. 3-4. In one or more embodiments, the client selects the file from the volume for writing data without being aware of whether the volume or its corresponding cache has been mounted to the client. In some embodiments, the client may be aware of whether the volume or the corresponding cache is mounted but the volume contents are presented to the client in the same way regardless of which is mounted.

Operation 804 includes obtaining, for a cache that corresponds to the volume and that is hosted by the first node, a write delegation for the selected file to allow processing of the write request. The cache corresponds to the volume by being directly associated with the volume or with a volume group that includes the volume. The cache may be, for example, cache 338 in FIGS. 3-5. The cache resides between the client and the data storage node that stores the volume. For example, the cache may be physically located closer to the client than the data storage node. In some cases, the cache may reside “between” the client and the data storage node storing the volume by having a shorter data transmission time from the client to the cache as compared to from the client to the data storage node. In some cases, the cache may reside “between” the client and the data storage node by being in a cluster of nodes that is closer to the client than the cluster of nodes managing access to the data storage node.

The write delegation for the selected file grants the cache permission to write to the selected file. The write delegation may be part of a read-write delegation that also grants the cache permission to read from the selected file or may be a separate delegation from a read delegation. Further, the write delegation prevents other processes (e.g., other processes operating within the node, other client processes, other processes operating at a different node, and/or other processes operating at a different cluster, etc.) from accessing the selected file until the write delegation of the cache is revoked.

Operation 806 includes writing the data to a cache file in the cache that corresponds to the selected file. The cache file corresponds to the selected file by being designated for storing portions of data to be read from or written to the selected file with reduced read latency or write latency, respectively. For example, data that is written to the cache file is designated for being written to the selected file.

Operation 808 includes sending a response to the client after the data is written to the cache file. The response confirms that the write operation has been completed. Writing the data to the cache file prior to the data being written to the selected file of the volume reduces the write latency associated with the write request because the overall time it takes to the write the data to the cache file is less than the overall time it takes to write the data directly to the selected file of the volume. Further, the time it takes to confirm that the write has been completed is reduced.

Operation 810 includes initiating a write-back of accumulated data in the cache to the volume when at least one of a cache file threshold, a cache threshold, or an idle threshold is met. The cache file threshold, the cache threshold, and the idle threshold may be, for example, the cache file threshold 348 in FIGS. 3-5, the cache threshold 506 in FIG. 5, and the idle threshold 508 in FIG. 5, respectively. These thresholds may be implemented in a manner similar to the thresholds described in operation 708 in FIG. 7. In operation 810, all or only a portion of the accumulated data in the cache is written back to the volume.

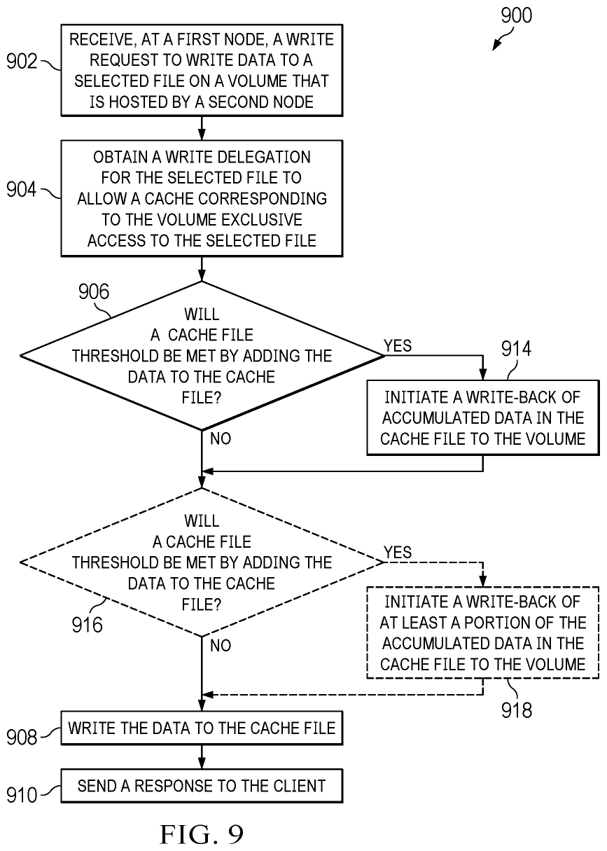

FIG. 9 is a flow diagram of a process 900 for write-back caching in accordance with one or more example embodiments. The process 900 may be implemented by one or more processors executing computer-readable instructions (e.g., from one or more computer-readable media) to perform the functions described herein. The process 900 may be implemented using one or more processors in a node in a cluster such as, for example, first node 130, second node 132, or third node 134 in FIG. 1. In some cases, the process 900 may be implemented by one or more processors of a data storage apparatus, such as, for example, one of the data storage apparatuses 202(1)-202(n) described in connection with FIG. 2. In one or more embodiments, the process 900 may be implemented by one or more processors of a node such as, for example, node 306 in FIGS. 3-4. Further, the process 900 may be implemented by, for example, disk module 314 in FIGS. 3-5, disk module 318 in FIGS. 3-4, and/or disk module 322 in FIGS. 3-4.

Operation 902 includes receiving, at a first node, a write request to write data to a selected file on a volume that is hosted by a second node. In one or more embodiments, the first node is in a first cluster and the second node is in a second cluster that is different from the first cluster. In other embodiments, the first node and the second node belong to the same cluster. The first node may be, for example, node 306 in FIGS. 3-4. The second node may be, for example, node 310 in FIGS. 3-4 (or alternatively, node 308 in FIGS. 3-4). Operation 902 may be implemented in a manner similar to operations 702 and 802 in FIGS. 7 and 8, respectively.

Operation 904 includes obtaining a write delegation for the selected file to allow a cache corresponding to the volume exclusive access to the selected file. The cache may be hosted by the first node. Operation 904 may be implemented in a manner similar to operation 804 in FIG. 8.

Operation 906 includes determining whether a cache file threshold will be met by adding the data to the cache file. The cache file threshold is a threshold for an amount of accumulated data in a cache file on the cache, where the cache file corresponds to the selected file. The cache file threshold for the amount of accumulated data in the cache file may be set to allow multiple write requests for the selected file to be processed before a write-back of the accumulated data in the cache file is initiated. In one or more embodiments, the cache file threshold is set to a value between 64 kilobytes and 10 gigabytes. For example, the cache file threshold may be set to a value of 1, 2, 3, 4, 5, 6, 7, 8, 9, or 10 gigabytes. In some cases, the cache file threshold is set to a default value (e.g., 500 kilobytes, 800 kilobytes, 1 megabytes, 5 megabytes, etc.). In some cases, the cache file threshold may be set to a percentage of the overall size of the cache file.

If the cache file threshold will not be met, process 900 proceeds to operation 908 and then operation 910 described below; otherwise, process 900 proceeds to operation 914 described below.

Operation 908 includes writing the data to the cache file. Operation 910 includes sending a response to the client after the data is written to the cache file. This response confirms that the write has been completed.

Operation 914 includes initiating a write-back of the accumulated data in the cache file to the selected file on the volume, with the process 900 then proceeding to operation 908. In one or more embodiments, the write-back initiated in operation 914 may include writing all of the accumulated data in the cache file to the selected file on the volume and flushing (or clearing) the cache file.

In one or more embodiments, process 900 optionally includes performing operation 916 prior to performing operation 908 described above. Operation 916 includes determining whether a cache threshold will be met by adding the data to the cache file.

The cache threshold (e.g., cache threshold 506 in FIG. 5) for the amount of accumulated data in the cache may be selected to ensure that the cache does not end up with an overly large amount of data that has yet to be written back. This type of accumulation may happen, for instance, when individual writes are smaller than the cache file threshold. In one or more embodiments, the cache threshold may be set to a value between 1 megabyte and 10 terabytes. For example, the cache threshold may be set to a value of 1 megabyte, 10 megabytes, 100 megabytes, 1 gigabyte, 10 gigabytes, 100 gigabytes, 1 terabyte, 10 terabytes, or some other number. In some cases, the cache threshold may be set to a default value (e.g., 6 gigabytes, 8 gigabytes, 10 gigabytes, etc.). The cache threshold may be set in units of bytes (e.g., megabytes, gigabytes, terabytes, etc.) or data blocks. In some cases, the cache threshold may be set to a percentage of the overall size of the cache.

If the cache threshold will not be met, the process 900 proceeds to operation 908 as described above. If the cache threshold will be met, the process 900 proceeds to operation 918, which includes initiating a write-back of at least a portion of the accumulated data in the cache to the volume, with the process 900 then proceeding to operation 908 as described above. The write-back in operation 918 may include writing some or all of the accumulated data in the cache to the volume and flushing (or clearing) the respective portions of the cache.

Thus, in one or more embodiments, process 900 may include performing both the cache file threshold check in operation 906 and the cache threshold check in operation 916 prior to writing data to the cache file in operation 908. In some cases, operation 916 (cache threshold check) may be performed prior to operation 906 (cache file threshold check). In such cases, operation 906 (cache file threshold check) may be optionally omitted if the write-back in operation 918 is performed and if this write-back includes the flushing the cache file.

The new data may be written to the cache file in operation 908 after flushing of the cache ensures that writing the new data to the cache file will not cause either the cache file threshold for the cache file or the cache threshold for the cache to be exceeded. For example, in some cases, if the write-back in operation 914, the write-back in operation 918, or both are initiated, operation 908 may be performed only after these write-backs are completed.

In other embodiments, operation 908 may be initiated prior to the completion of a write-back. For example, if the write-back in operation 918 includes flushing the cache file as well as other portions of the cache, the writing the new data to the cache file in operation 908 may be performed once the cache file has been flushed, even if the rest of the cache has not yet finished being flushed. More particularly, the write in operation 908 may occur once the cache file has been flushed and once sufficient space within the cache has been made for the new data that is to be written. As another example, the writing of the new data to the cache file in operation 908 may be performed prior to an entirety of the accumulated data that is part of the write-back being written back to the volume and flushed from the cache. In this manner, the writing of the new data to the cache file in operation 908 may be performed even if the cache has not yet been fully flushed as long as there is both sufficient space within both the cache and cache file for the new data, as determined by the cache file threshold, the cache threshold, and the amount of the new data to be written.

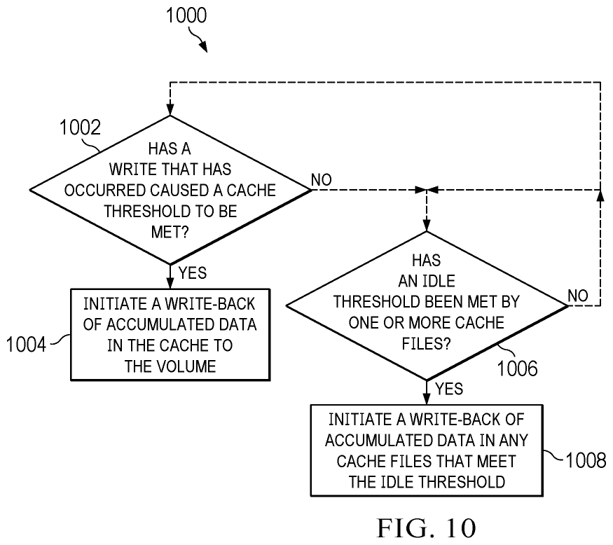

FIG. 10 is a flow diagram of a process 1000 for clearing at least a portion of a cache in accordance with one or more example embodiments. The process 1000 may be implemented by one or more processors executing computer-readable instructions (e.g., from one or more computer-readable media) to perform the functions described herein. The process 1000 may be implemented using one or more processors in a node in a cluster such as, for example, first node 130, second node 132, or third node 134 in FIG. 1. In some cases, the process 1000 may be implemented by one or more processors of a data storage apparatus, such as, for example, one of the data storage apparatuses 202(1)-202(n) described in connection with FIG. 2. In one or more embodiments, the process 1000 may be implemented by one or more processors of a node such as, for example, node 306 in FIGS. 3-4. Further, the process 1000 may be implemented by, for example, disk module 314 in FIGS. 3-5.

Process 1000 may optionally begin with operation 1002. Operation 1002 may be performed in response to, for example, without limitation, a write that has just occurred to a cache (e.g., cache 338 in FIGS. 3-5). Operation 1002 includes determining whether a write that has occurred has caused a cache threshold to be met. The cache threshold is for a total amount of accumulated data in the cache. As previously discussed, the cache threshold (e.g., cache threshold 506 in FIG. 5) for the amount of accumulated data in the cache may be set to ensure that the cache does not end up with an overly large amount of data that has yet to be written back. This type of accumulation may happen, for instance, when individual writes are smaller than the cache file threshold. In one or more embodiments, the cache threshold may be set to a value between 1 megabyte and 11 terabytes. The cache threshold may be set in units of bytes (e.g., megabytes, gigabytes, terabytes, etc.) or data blocks. In some cases, the cache threshold may be set to a percentage of the overall size of the cache.

If the cache threshold has been met, process 1000 proceeds to operation 1004, which includes initiating a write-back of at least a portion of the accumulated data in the cache to the volume. In one or more embodiments, all of the entries in the cache are cleared (flushed). In other embodiments, only a portion of the accumulated data is cleared. For example, in some cases, only those cache files that have been idle for at least a minimum idle time may be cleared. This minimum idle time may be the same as the idle threshold previously discussed or may be a different value. For example, the minimum idle time may be set to a value between 15 seconds and 5 minutes. In some cases, the minimum idle time may be set to a value less than the idle threshold.

Returning to operation 1002, if the cache threshold has not been met, the process 1000 optionally proceeds to operation 1006, which includes determining whether the idle threshold has been met. The idle threshold may be a threshold for an amount of time that a cache file has been left idle. The idle threshold may be set to a value between, for example, 30 seconds and 11 minutes. In some cases, the idle threshold is set to a value that is more than the minimum idle time. If the idle threshold has been met, the process 1000 proceeds to operation 1008, which includes, initiating a write-back of the accumulated data in any cache files that meet the idle threshold. Otherwise, no action is taken. In some cases, the process 1000 optionally returns to one of operation 1002 (e.g., in instances where another write has occurred) or operation 1006 (e.g., in instances where a triggering event has occurred),

In one or more embodiments, process 1000 may include the subprocess formed by operations 1002 and 1004, with operations 1006 and 1008 being excluded. In other embodiments, process 1000 includes the subprocess formed by operations 1006 and 1008, with operations 1002 and 1004 being excluded. In these such embodiments, operation 1006 may be performed in response to a triggering event. The triggering event may be the lapse of a timer, receiving a command to scrub the cache, or another type of event. In still other embodiments, the subprocess formed by operations 1002 and 1004 and the subprocess formed by operations 1006 and 1008 may be independently performed.

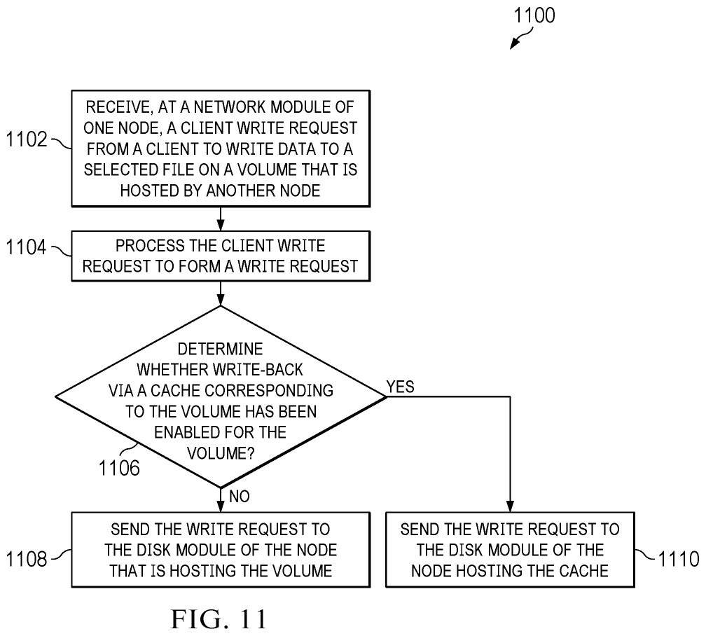

FIG. 11 is a flow diagram of a process 1100 for generating a write request in accordance with one or more example embodiments. The process 1100 may be implemented by one or more processors executing computer-readable instructions (e.g., from one or more computer-readable media) to perform the functions described herein. The process 1100 may be implemented using one or more processors in a node in a cluster such as, for example, first node 130, second node 132, or third node 134 in FIG. 1. In some cases, the process 1100 may be implemented by one or more processors of a data storage apparatus, such as, for example, one of the data storage apparatuses 202(1)-202(n) described in connection with FIG. 2. In one or more embodiments, the process 1100 may be implemented by one or more processors of a node such as, for example, node 306 in FIGS. 3-4. Further, the process 900 may be implemented by, for example, network module 312, network module 316, and/or network module 320 in FIGS. 3-4. Process 1100 may be one example of an implementation for generating and sending a write request such as, for example, the write request that is received in operation 702 in FIG. 7, the write request that is received in operation 802 in FIG. 8, the write request that is received in operation 902 in FIG. 9.

Operation 1102 includes receiving, at a network module of one node, a client write request from a client to write data to a selected file on a volume that is hosted by another node. In one or more embodiments, these two nodes reside in two different clusters. In other embodiments, these two nodes belong to the same cluster. As one example, one node may be node 306 in FIGS. 3-4 and the other node may be node 310 in FIGS. 3-4 (or alternatively, node 308 in FIGS. 3-4).

Operation 1104, which includes processing the client write request to form a write request. The write request may be, for example, a modified or transformed version of the client write request received from the client. For example, the network module may process the client write request to generate the write request in a different format than the client write request.

Operation 1106 includes determining, by the network module, whether write-back via a cache corresponding to the volume has been enabled for the volume. In one or more embodiments, operation 1102 may be performed by the network module sending a query to the volume to determine whether a flag has been set on the volume that indicates that write-back has been enabled for the volume. The flag may be, for example, a persistent RAID level write-back flag that is set on the volume. When the volume is part of a volume group, the persistent RAID level write-back flag may be set on each volume in the volume group. The cache may be hosted by the same node at which the client write request is received or by another node in the same cluster. In some embodiments, the cache may be hosted by a node that is in a different cluster from the cluster of the node that receives the client write request and/or the cluster of the node that hosts the volume.

If the network module determines that write-back has not been enabled, process 1100 proceeds to operation 1108, which includes sending the write request to the disk module of the node that is hosting the volume. If, however, the network module determines that write-back has been enabled, process 1100 proceeds to operation 1110, which includes sending the write request to the disk module of the node that is hosting the cache.

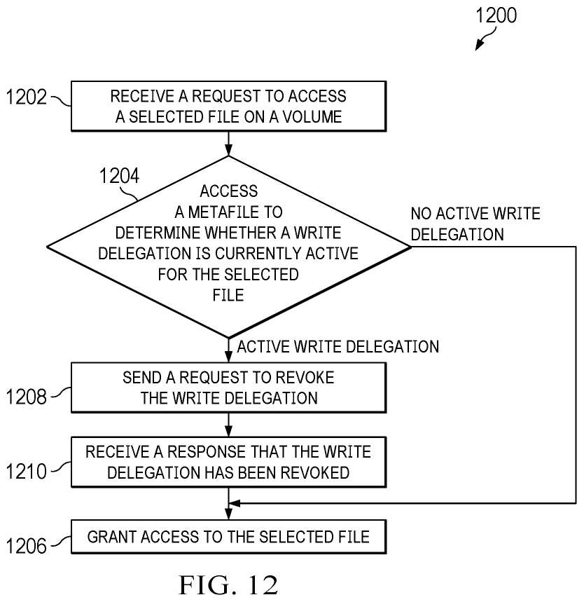

FIG. 12 is a flow diagram of a process 1200 for managing access to a selected file on a volume in accordance with one or more example embodiments. The process 1200 may be implemented by one or more processors executing computer-readable instructions (e.g., from one or more computer-readable media) to perform the functions described herein. The process 1200 may be implemented using one or more processors in a node in a cluster such as, for example, first node 130, second node 132, or third node 134 in FIG. 1. In some cases, the process 1200 may be implemented by one or more processors of a data storage apparatus, such as, for example, one of the data storage apparatuses 202(1)-202(n) described in connection with FIG. 2. In one or more embodiments, the process 1200 may be implemented by one or more processors of a node such as, for example, node 306 in FIGS. 3-4.

Operation 1202 includes receiving a request to access a selected file on a volume. This request may be received at a same node that is hosting the volume or a different node. In some cases, the request may be received at a node that is in a same cluster as the node hosting the volume or in a different cluster from the node hosting the volume. The request may be to read data from the selected file or write data to the selected file.

Operation 1204 includes accessing a metafile to determine whether a write delegation is currently active for the selected file. In one or more embodiments, the metafile may be, for example, a volume metafile that is associated with the volume. For example, the volume metafile (e.g., volume metafile 346 in FIGS. 3-4) may be maintained by the disk module that owns the volume. In other examples, operation 1204 may be performed by the node that receives the request to access the data sending out a query to the hosting nodes of all caches corresponding to the volume. This query may be to determine whether any of the cache metafiles (e.g., cache metafile 344 in FIGS. 3-4) associated with these caches indicates that its corresponding cache has an active write delegation for the selected file.

If a determination is made that no write delegation is currently active (e.g., has been granted) for the selected file, process 1200 proceeds to operation 1206, which includes granting access to the selected file. This access may be granted by allowing data from the selected file to be read or data to be written to the selected file. In some cases, the access is granted via a cache such that the data may be read from the volume via a cache or the data may be written to the volume via write-back caching, as described herein.

If a determination is made that a write delegation is currently active (e.g., has been granted) for the selected file, process 1200 proceeds to operation 1208, which includes sending a request to revoke the write delegation. In one or more embodiments, the request is sent to the disk module of the node hosting the volume. In other embodiments, the request is sent to the disk module of the node hosting the cache that currently has the active write delegation. Thus, this revocation request may be managed by the disk module hosting the cache or the disk module hosting the volume. Before a response confirming revocation of the write delegation is sent, the cache that had the write delegation may be flushed such that any accumulated data for the selected file (and in some cases, other accumulated data for one or more other files on the volume) is written back to the volume. This helps ensure consistency of data when managing concurrent access to the volume at the file system level.

Operation 1210 includes receiving a response that the write delegation has been revoked. This response indicates that the selected file is free to be accessed. The process 1200 then proceeds to operation 1206 as described above such that a new write delegation may be put in place for the cache.

As a result of the methodologies discussed above, the embodiments described herein provide improvements in write latency and throughput when write-back caching is performed between clusters (e.g., the cache being hosted by a node one cluster and its underlying corresponding volume being hosted by a node in another cluster). For example, a write latency of milliseconds or tens of milliseconds may be reduced by at least 100 percent up to about 600%. For example, in various cases, using the embodiments described herein, write latency may be improved (e.g., reduced) more than 100%, more than 200%, more than 300%, more than 500%, or more than 600%. Further, the embodiments described herein help keep data consistent at the underlying volume, enabling the volume to be sufficiently resilient to weather various scenarios such as shut-downs, reboots, and other such events in a cross-cluster environment.

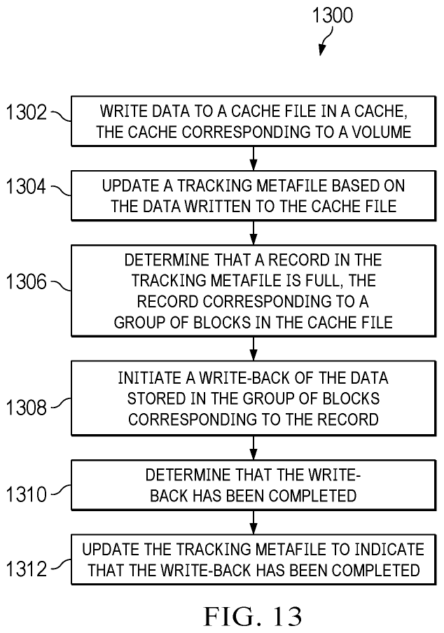

FIG. 13 is a flow diagram of a process 1300 for performing asynchronous write-back operations in accordance with one or more example embodiments. The process 1300 may be implemented by one or more processors executing computer-readable instructions (e.g., from one or more computer-readable media) to perform the functions described herein. The process 1300 may be implemented using one or more processors in a node in a cluster such as, for example, first node 130, second node 132, or third node 134 in FIG. 1. In some cases, the process 1300 may be implemented by one or more processors of a data storage apparatus, such as, for example, one of the data storage apparatuses 202(1)-202(n) described in connection with FIG. 2. In one or more embodiments, the process 1300 may be implemented by one or more processors of a node such as, for example, node 306 or node 310 in FIGS. 3-4.

Operation 1302 includes writing data to a cache file in a cache, the cache corresponding to a volume. The cache may be, for example, cache 338 in FIGS. 3-4. The cache file may, be, for example, cache file 350 in FIG. 3. The write may occur in response to, for example, a write request.

Operation 1304 includes updating a tracking metafile based on the data written to the cache file. The tracking metafile may be, for example, tracking metafile 356 in FIGS. 3-4. Updating the tracking metafile may include, for example, updating a record in the tracking metafile that corresponds to the cache file. Updating the record may include, for example, identifying one or more existing records in the tracking metafile that corresponds to the portion of the cache file (e.g., the portion containing the one or more fbns of the cache file) that is being written to as part of the write. An existing record may include a bitmap made up of a plurality of bits, each bit corresponding to at least one different block (data block having fbn) of the cache file. Updating the record includes updating the value of the one or more bits corresponding to the one or more fbns written to as part of the write. For example, for a particular block that is written to, the corresponding bit may be updated from a value of “0” to a value of “1” indicating that the block represented by that bit has been modified (e.g., by being newly written to, by having existing data modified, or being otherwise “dirtied”).

In some embodiments, where the block of the cache file being written to is does not already have a corresponding record in the tracking metafile, updating the tracking metafile includes creating a new record for a group of blocks that includes this block. The value of the bit corresponding to that fbn is then updated to have a value indicating that it has been modified. For example, the value of the bit may be changed from “0” to “1” (or, in alternative embodiments, from “1” to “0”). The group of blocks may be indexed by a corresponding group of file block numbers. These file block numbers may be, for example, a sequence of blocks (e.g., a sequence of fbns that includes the fbn being written to).

Operation 1306 includes determining that a record in the tracking metafile is full, the record corresponding to a group of blocks of the cache file. A record is considered “full” when all the bits have been updated to indicate that the corresponding blocks (e.g., fbns) represented by the bits have been modified (or “dirtied”). In other words, the sequence of fbns represented by the record have all been written to or “modified” since the creation of the record or since a last write-back operation of the record).

Operation 1308 includes initiating a write-back of the data stored in the group of blocks corresponding to the record. For example, initiating the write-back may include encoding the data stored in the fbns of the corresponding portion of the cache file corresponding to the tracking metafile. Operation 1304 may further include performing the write-back by sending the encoded data in one or more write-back messages to a corresponding file in a corresponding volume.

Operation 1310 includes determining that the write-back has been completed. The write-back has been completed when the one or more write-back messages have led to the corresponding data being stored in the volume.

Operation 1312 includes updating the tracking metafile to indicate that the write-back has been completed. This updating may be performed by, for example, deleting the record from the tracking metafile. Deleting the record from the tracking metafile essentially designates that the fbns are available for future writes. A new record for those fbns may be created at a later time should a future write to the fbns occur. In other embodiments, updating the tracking metafile in operation 1312 includes changing the values of the bits in the bitmap of the record to show that the record is “empty” and that the corresponding fons are available for future writes.

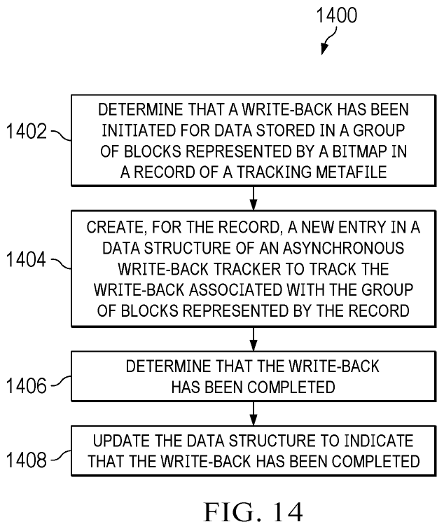

FIG. 14 is a flow diagram of a process 1400 for tracking asynchronous write-back operations in accordance with one or more example embodiments. The process 1400 may be implemented by one or more processors executing computer-readable instructions (e.g., from one or more computer-readable media) to perform the functions described herein. The process 1400 may be implemented using one or more processors in a node in a cluster such as, for example, first node 130, second node 132, or third node 134 in FIG. 1. In some cases, the process 1400 may be implemented by one or more processors of a data storage apparatus, such as, for example, one of the data storage apparatuses 202(1)-202(n) described in connection with FIG. 2. In one or more embodiments, the process 1400 may be implemented by one or more processors of a node such as, for example, node 306 or node 310 in FIGS. 3-4.

Operation 1402 includes determining that a write-back has been initiated for the data stored in a group of blocks represented by a bitmap in a record of a tracking metafile. The tracking metafile may be, for example, tracking metafile 356 in FIGS. 3-4. The group of blocks may be, for example, a sequence of blocks (e.g., fbns).

Operation 1404 includes creating a new entry in a data structure of an asynchronous write-back tracker to track the write-back associated with the group of blocks represented by the record. The asynchronous write-back tracker may be, for example, asynchronous write-back tracker 358 in FIGS. 3-4. The data structure may be, for example, data structure 630 in FIG. 6. The data structure may be, for example, a hash data structure. Each entry of the data structure may include, for example, a local file system identifier (fsid), a cache identifier (e.g., an identifier for the cache file corresponding to record 604), and a list of the file block numbers for the group of blocks. The data structure may be protected by spinlock. Entries in the data structure of the asynchronous write-back tracker indicate those file block numbers for which writes are prevented until write-back has been completed.

Operation 1406 includes determining that the write-back has been completed. The write-back is completed when the data in the file block numbers has been written to the volume.

Operation 1408 includes updating the data structure to indicate that the write-back has been completed. Updating the data structure may include, for example, deleting the entry for the record from the data structure in response to determining that the write-back has been completed. Deleting the entry frees the corresponding file block numbers for writes. Thus, any incoming write requests to write to the group of blocks may proceed without a forced delay.

Process 1400 is used to track write-backs that occur based on records being full (asynchronous write-backs). Tracking asynchronous write-backs in the manner described above helps prevent data loss that might otherwise occur due to concurrent writes and write-backs.

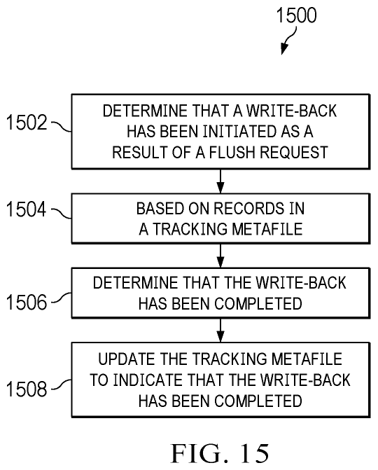

FIG. 15 is a flow diagram of a process 1500 for managing a tracking metafile in accordance with one or more example embodiments. The process 1500 may be implemented by one or more processors executing computer-readable instructions (e.g., from one or more computer-readable media) to perform the functions described herein. The process 1500 may be implemented using one or more processors in a node in a cluster such as, for example, first node 130, second node 132, or third node 134 in FIG. 1. In some cases, the process 1500 may be implemented by one or more processors of a data storage apparatus, such as, for example, one of the data storage apparatuses 202(1)-202(n) described in connection with FIG. 2. In one or more embodiments, the process 1500 may be implemented by one or more processors of a node such as, for example, node 306 or node 310 in FIGS. 3-4.

Operation 1502 includes determining that a write-back has been initiated as a result of a flush request. The flush request may have been generated based on, for example, at least one of a cache threshold, cache file threshold, idle threshold being met, or some other similar type of threshold being met. The flush request, which may also be referred to as an evict request, is a request to write-back accumulated data in a cache (e.g., accumulated data in a particular cache file, accumulated data in any cache files that meet the file threshold, or all data stored in a cache) to a corresponding volume.

Operation 1504 includes performing the write-back based on records in a tracking metafile. Operation 1504 may include, for example, identifying all records in the tracking metafile (e.g., tracking metafile 356) and performing write-back for all data represented by those records. Operation 1504 may include, for example, identifying the records in multiple tracking metafiles and performing write-back for all data represented by the records in the multiple tracking metafiles. For example, the keys of the records, and thereby the records, in a tracking metafile may be collected and designated as being in a flush state indicating that the data represented by the records identified by those keys is to be written back to the volume. After write-back has been completed, the tracking metafile is updated to indicate this completion. For example, the key for that record, and thereby the record, may be designated as being in a deletion phase such that the record is marked for deletion. In other examples, the bits of the bitmap in the record may be updated with new values to show the record as being “empty” and the corresponding blocks (e.g., fbns) being available for writes.

Because write-back may be performed based on the records in the tracking metafile(s) and because asynchronous write-backs occur in the background frequently without interrupting sequential writes, the number of records and thereby, the amount of data, that needs to be written back based on the flush request is reduced. Thus, the impact performing the flush of the cache or cache file(s) on writes to the cache or other operations may be reduced. For example, the computing resources needed to perform the flush may be reduced and the time during which the cache is unavailable for writes due to being part of a flush may be reduced.

Operation 1506 includes determining that the write-back has been completed.

Operation 1508 includes updating the tracking metafile to indicate that the write-back has been completed. Updating the tracking metafile may include, for example, deleting all records in one or more tracking metafiles corresponding to data that was written back to the volume as part of the write-back. In other examples, updating the tracking metafile may include “emptying” all records that have been written back by updating their corresponding bit values.

In other embodiments, operation 1506 and operation 1508 may be performed for each record as the write-back for that record is completed. For example, operation 1506 may instead include determining that the write-back for a record has been completed. Operation 1508 may instead include updating the tracking metafile by deleting the record for which a particular write-back has been completed or updating the bitmap of the record.

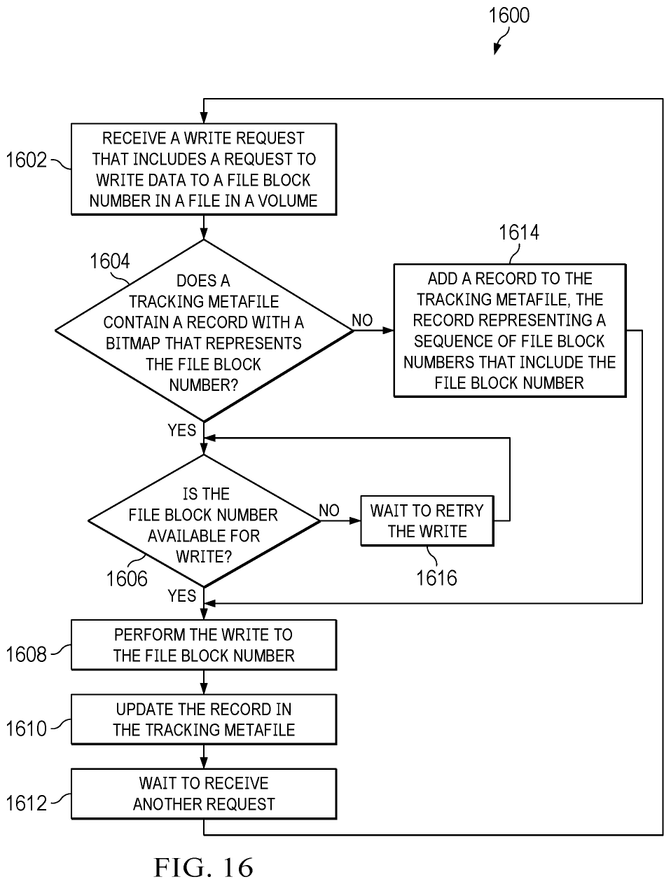

FIG. 16 is a flow diagram of a process 1600 for managing write operations in accordance with one or more example embodiments. The process 1600 may be implemented by one or more processors executing computer-readable instructions (e.g., from one or more computer-readable media) to perform the functions described herein. The process 1600 may be implemented using one or more processors in a node in a cluster such as, for example, first node 130, second node 132, or third node 134 in FIG. 1. In some cases, the process 1600 may be implemented by one or more processors of a data storage apparatus, such as, for example, one of the data storage apparatuses 202(1)-202(n) described in connection with FIG. 2. In one or more embodiments, the process 1600 may be implemented by one or more processors of a node such as, for example, node 306 or node 310 in FIGS. 3-4.

Operation 1602 includes receiving a write request that includes a request to write data to a file block number in a file in a volume. The write request itself may include a request to write to multiple file block numbers. Process 1600 is described with respect to a single file block number but may be similarly performed or implemented for multiple file block numbers.

Operation 1604 includes determining whether a tracking metafile contains a record with a bitmap that represents the file block number. Such a record would include a bitmap with a plurality of bits in which a bit of the plurality of bits represents at least the file block number. If the tracking metafile contains the record, process 1600 proceeds to operation 1606.

Operation 1606 includes determining whether the file block number is available for write. Operation 1606 may include determining whether a bit in the bitmap of the record indicates that the file block number is available for write. In some embodiments, operation 1606 additionally includes consulting an asynchronous write-back tracker (e.g., that includes a hash data structure) to determine whether the file block number is available for write. The asynchronous write-back tracker may indicate that the file block number is unavailable for write when the corresponding record is undergoing a write-back operation. If both the bit and the asynchronous write-back tracker indicate that the file block number is available for write, process 1600 proceeds to operation 1608.

Operation 1608 includes performing the write to the file block number.

Operation 1610 includes updating the record in the tracking metafile, with the process 1600 proceeding to operation 1612.

Operation 1612 includes waiting until operation 1602 can be performed again.

With reference again to operation 1604, if the tracking metafile does not contain the record, process 1600 proceeds to operation 1614.

Operation 1614 includes adding a record to the tracking metafile, the record representing a sequence of file block numbers that include the file block number, with the process 1600 then proceeding to operation 1608 as described above.

With reference again to operation 1606, if the bit indicates that the file block number is not available for write, process 1600 includes operation 1616.

Operation 1616 which includes waiting to retry the write, with the process 1600 returning to operation 1600.

The above-described operations of process 1600 may be performed in a manner that does not interfere with asynchronous write-backs that can occur. For example, as a record's bits are updated, a separate process may be used to determine when a record becomes “full” such that a write-back operation needs to be triggered.

### V. Additional Considerations

All examples and illustrative references are non-limiting and should not be used to limit the claims to specific implementations and examples described herein and their equivalents. For simplicity, reference numbers may be repeated between various examples. This repetition is for clarity only and does not dictate a relationship between the respective examples. Finally, in view of this disclosure, particular features described in relation to one aspect or example may be applied to other disclosed aspects or examples of the disclosure, even though not specifically shown in the drawings or described in the text.

The headers and subheaders between sections and subsections of this document are included solely for the purpose of improving readability and do not imply that features cannot be combined across sections and subsection. Accordingly, sections and subsections do not describe separate embodiments.

The terms and expressions which have been employed are used as terms of description and not of limitation, and there is no intention in the use of such terms and expressions of excluding any equivalents of the features shown and described or portions thereof, but it is recognized that various modifications are possible within the scope of what is claimed. Thus, it should be understood that although one or more inventions have been specifically disclosed by the embodiments and optional features described herein, modification and variation of the concepts disclosed herein may be resorted to by those skilled in the art, and that such modifications and variations are considered to be within the scope of the one or more inventions described herein and the invention described in the appended claims.

Some embodiments of the present disclosure include a system including one or more data processors. In some embodiments, the system includes a non-transitory computer readable storage medium containing instructions which, when executed on the one or more data processors, cause the one or more data processors to perform part or all of one or more methods and/or part or all of one or more processes disclosed herein. Some embodiments of the present disclosure include a computer-program product tangibly embodied in a non-transitory machine-readable storage medium, including instructions configured to cause one or more data processors to perform part or all of one or more methods and/or part or all of one or more processes disclosed herein.

The description provides preferred exemplary embodiments only, and is not intended to limit the scope, applicability, or configuration of the disclosure. Rather, the description of the preferred exemplary embodiments will provide those skilled in the art with an enabling description for implementing various embodiments. It is understood that various changes may be made in the function and arrangement of elements without departing from the spirit and scope as set forth in the appended claims.

The present embodiments may be implemented using hardware, software, firmware, or a combination thereof. Accordingly, it is understood that any operation of the computing systems of the computing environment 100 in FIG. 1, the network environment 200 in FIG. 2, or the cluster network 300 or portions thereof in FIGS. 3-5 may be implemented by a computing system using corresponding instructions stored on or in a non-transitory computer-readable medium accessible by a processing system. For the purposes of this description, a tangible computer-usable or computer-readable medium can be any apparatus that can store the program for use by or in connection with the instruction execution system, apparatus, or device. The medium may include non-volatile memory including magnetic storage, solid-state storage, optical storage, cache memory, and RAM.

The foregoing outlines features of several examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the examples introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method comprising:
writing data to a cache file in a cache, the cache corresponding to a volume;
updating a tracking metafile based on the data written to the cache file;
determining that a record in the tracking metafile is full, the record corresponding to a group of blocks in cache file;
initiating a write-back of data stored in the group of blocks in the cache file that corresponds to the record to the volume; and
determining that the write-back has been completed; and
updating the tracking metafile to indicate that the write-back has been completed.

2. The method of claim 1, wherein updating the tracking metafile based on the data written to the cache file comprises:
updating at least one bit in a bitmap of the record that corresponds to the group of blocks in the cache file.

3. The method of claim 1, wherein determining that the record in the tracking metafile is full comprises:
determining that each bit in a plurality of bits that form a bitmap of the record has a value that indicates that a file block number corresponding to each bit has been modified since creation of the record, the file block number being of the cache file corresponding to the record.

4. The method of claim 1, wherein initiating the write-back comprises:
encoding data stored in the group of blocks represented by the record to be sent in one or more write-back messages to the volume.

5. The method of claim 1, wherein updating the tracking metafile to indicate that the write-back has been completed comprises:
deleting the record from the tracking metafile to thereby make file block numbers of the group of blocks corresponding to the record for future writes.

6. The method of claim 1, wherein updating the tracking metafile to indicate that the write-back has been completed comprises:
changing values for bits in the record to indicate that the corresponding group of blocks is available for future writes.

7. The method of claim 1, wherein the record includes metadata and a bitmap, the bitmap including a plurality of bits in which each bit of the plurality of bits represents at least one file block number of at least one block in the group of blocks in the cache file corresponding to the record.

8. The method of claim 1, wherein the group of blocks corresponds to a sequence of file block numbers and wherein the record includes a key that includes a cache file identifier for the cache file and an identifier for a first file block number in the sequence of file block numbers.

9. The method of claim 1, wherein the record includes a bitmap that includes a plurality of bits representing a sequence of file block numbers for the group of blocks of the cache file that corresponds to the record.

10. The method of claim 1, wherein initiating the write-back includes tracking the write-back in a data structure that indicates which file block numbers of the cache file are associated with an in-progress write-back.

11. A computing device comprising:
a memory containing a machine-readable medium comprising machine executable code having instructions stored thereon; and
a processor coupled to the memory, the processor configured to execute the machine executable code to:
write data to a cache file in a cache, the cache corresponding to a volume;
update a tracking metafile based on the data written to the cache file;
determine that a record in the tracking metafile is full, the record corresponding to a group of blocks in the cache file;
initiate a write-back of data stored in the group of blocks in the cache file that corresponds to the record to the volume;
create an entry in a hash data structure of an asynchronous write-back tracker to track the write-back associated with the group of blocks;
determine that the write-back has been completed; and
update the tracking metafile and the hash data structure to indicate that the write-back has been completed.

12. The computing device of claim 11, wherein the record includes a key that uniquely identifies the record in the tracking metafile and wherein the record includes metadata that includes information about the record.

13. The computing device of claim 11, wherein the record includes a key that includes a cache file identifier for the cache file and an identifier for a first file block number in a sequence of file block numbers for the group of blocks represented by the record.

14. The computing device of claim 11, wherein the record includes a bitmap that includes a plurality of bits in which each bit in the plurality of bits represents at least one block in the group of blocks.

15. The computing device of claim 11, wherein the processor is further configured to execute the machine executable code to:
determine that the record in the tracking metafile is full by determining that each bit in a plurality of bits that form a bitmap of the record has a value that indicates that a file block number corresponding to each bit has been modified since creation of the record, the file block number being of the cache file corresponding to the record.

16. The computing device of claim 11, wherein, to update the tracking metafile and the hash data structure to indicate that the write-back has been completed, the processor is further configured to execute the machine executable code to:
delete the record from the tracking metafile to make file block numbers of the group of blocks in the cache file available for future writes; and
delete the entry from the hash data structure, wherein deleting the entry from the hash data structure permits a future write to the group of blocks to proceed.

17. A non-transitory machine-readable medium having stored thereon instructions for performing a method comprising machine-executable code which, when executed by at least one machine, causes the at least one machine to:
write data to a cache file in a cache, the cache corresponding to a volume;
update a record in a tracking metafile based on the data written to the cache file, the record including a key, metadata, and a bitmap that represents a sequence of file block numbers in the cache file;
determine that the record in the tracking metafile is full;
initiate a write-back of data stored in the sequence of file block numbers represented by the bitmap; and
determine that the write-back has been completed; and
delete the record from the tracking metafile.

18. The non-transitory machine-readable medium of claim 17, wherein the bitmap includes a plurality of bits in which each bit of the plurality of bits represents a different file block number in the sequence of file block numbers.

19. The non-transitory machine-readable medium of claim 17, wherein the machine-executable code further causes the at least one machine to:
track the write-back of the data stored in the sequence of file block numbers using a hash data structure.

20. The non-transitory machine-readable medium of claim 17, wherein the key includes a cache file identifier for the cache file and an identifier for a first file block number in the sequence of file block numbers.

21. The non-transitory machine-readable medium of claim 17, wherein the machine-executable code further causes the at least one machine to:
create an entry in a hash data structure for the sequence of file block numbers represented by the record in response to the write-back being initiated; and
delete the entry from the hash data structure in response to the write-back being completed.
